(19) United States
(12) Patent Application Publication
(10) Pub. No.: US 2014/0093761 A1
(43) Pub. Date: Apr. 3, 2014

(54) LITHIUM SECONDARY BATTERY

(71) Applicant: HITACHI MAXELL ENERGY, LTD., (US)

(72) Inventors: Yuta Sakanaka, Otokuni-gun (JP); Akira Inaba, Otokuni-gun (JP); Masaaki Kibe, Otokuni-gun (JP); Yusuke Nakamura, Otokuni-gun (JP); Keiichiro Uenae, Otokuni-gun (JP); Masayuki Yamada, Otokuni-gun (JP); Kyoji Tsuji, Otokuni-gun (JP)

(73) Assignee: HITACHI MAXELL ENERGY, LTD., Otokuni-gun (JP)

(21) Appl. No.: 13/666,010

(22) Filed: Nov. 1, 2012

(30) Foreign Application Priority Data
Nov. 1, 2011 (JP) 2011-240044
Jan. 17, 2012 (JP) 2012-006962
Jan. 19, 2012 (JP) 2012-008583

(51) Int. Cl. H01M 2/12

(52) U.S. Cl. CPC H01M 2/1241
USPC 429/82

(57) ABSTRACT

There is provided a lithium secondary battery. The positive electrode includes a positive electrode mixture layer provided on one side or both sides of the current collector. The positive electrode active material includes a lithium-containing composite oxide including lithium and a transition metal. At least a part of the lithium-containing composite oxide includes nickel as transition metal. The non-aqueous electrolyte includes a halogen-substituted cyclic carbonate at a content of 0.5 to 5 mass %, when manufacturing the lithium secondary battery. The side part of the battery case includes two wide surfaces opposed to each other. The two wide surfaces are wider than the other surfaces in a side view. The side part has such a cleavable groove that is cleaved when an internal pressure of the battery exceeds a threshold. The cleavable groove is provided at a portion to intersect with a diagonal of the wide surfaces in the side view.

### TECHNICAL FIELD

The present invention relates to a lithium secondary battery with a high capacity and excellent safety.

### BACKGROUND OF THE INVENTION

In late years, there has been development of cell-phones and portable electronic equipments such as notebook-sized personal computers. Also, there has been practical use of electric cars. An electric source for these equipments has been demanded to make technological advance and improve a high stability for rechargeable batteries and capacitors. In particular, lithium secondary batteries have been focused as batteries with high energy density. Various improvements have been made for suitable electric sources of these equipments.

An anode active material of the existing lithium secondary battery has often included LiCoO₂ (Lithium Cobalt Oxide) because of its easy production and handling properties. However, since LiCoO₂ is prepared from Co (cobalt), a rare element raw material, it will be seriously concerned of resource shortages in the future. In addition, cobalt is expensive and its price is largely fluctuated. It has been, therefore, demanded to develop anode materials which are reasonable in price and stable in supply.

For example, an anode active material was proposed, in which Ni (nickel), Mn (manganese) and Co and other substituted element M are included with a specific ration that the atom ratio on the particle surface of the substitution element M for Ni, Mn and Co is larger than the average atom ratio of the whole particles of the substitution element M for Ni, Mn and Co. see Japanese Patent Laid-Open Publication No. 2006-202647. Since such an anode active material containing Ni has a larger capacity than LiCoO₂, it is expected to advance a capacity increase of lithium secondary batteries.

With respect to the active material materials of the negative electrode, instead of carbonaceous materials such as graphite conventionally used in lithium secondary batteries, materials such as silicon (Si) and tin (Sn) have been focused on since they allow more absorption and desorption of lithium (ions). In particular, SiOₓ was reported that a structure with ultrafine Si particles dispersed in SiO₂, had superior load characteristics. See Japanese Patent Laid-Open Publication Nos. 2004-047404, and 2005-259697.

By the way, in order to enhance a capacity of lithium secondary batteries, for example, it has been proposed to raise the charge stop voltage (at constant-current constant-voltage charge) at a level exceeding 4.2V prior to use. Such a condition is adopted in existing lithium secondary batteries including LiCoO₂ as an anode active material. However, as raising the charge stop voltage of the lithium secondary batteries, the risk will be increased especially in an abnormal condition where the battery is exposed to an excessive high temperature in a charged state. Thus, the improvement in safety has been demanded.

With respect to the safety of the lithium secondary batteries, for example, it has been proposed that a groove serving as a safety valve is provided on the side of the exterior can, i.e., a battery case. When the battery is exposed to a high temperature, gases are generated to raise the internal pressure. Then, the groove can be cleaved to release the gases to avoid the battery explosion. See Japanese Patent Laid-Open Publication No. 2003-297322.

### SUMMARY OF THE INVENTION

The first purpose of the present invention is to provide a lithium secondary battery having a high capacity and excellent in safety at an extreme high temperature. Also, the second purpose of the present invention is to provide a lithium secondary battery having a high capacity, excellent in safety at an extreme high temperature, and showing good storage characteristics. Furthermore, the third purpose of the present invention is to provide a lithium secondary battery having a high capacity, excellent in safety at an extreme high temperature, restricting the battery swelling, and showing good charge discharge cycle characteristics.

As the first aspect of the present invention, there is provided a lithium secondary battery. The battery case is shaped in a hollow column. The battery case encloses a positive electrode, a negative electrode, a non-aqueous electrolyte, and a separator. The positive electrode comprises a positive electrode mixture layer comprising a positive electrode active material, a conductive assistant and a binder on one side or both sides of a current collector. The positive electrode active material comprises a lithium-containing composite oxide comprising lithium and a transition metal. At least a part of the lithium-containing composite oxide includes nickel as the transition metal. The non-aqueous electrolyte used in the lithium secondary battery includes a halogen-substituted cyclic carbonate at a content of 0.5 to 5 mass %, when manufacturing the lithium secondary battery. The side part of the battery case includes two wide surfaces opposed to each other. The two wide surfaces are wider than the other surfaces in a side view thereof. The side part has such a cleavable groove that is cleaved when an internal pressure of the battery exceeds a threshold. The cleavable groove is provided at a portion to intersect with a diagonal of the wide surfaces in the side view.

As the second aspect of the present invention, there is provided a lithium secondary battery. The battery case is shaped in a hollow column. The battery case encloses a positive electrode a negative electrode, a non-aqueous electrolyte, and a separator. The positive electrode comprises a positive electrode mixture layer comprising a positive electrode active material, a conductive assistant and a binder, the positive electrode mixture layer provided on one side or both sides of a current collector. The positive electrode active material comprises a lithium-containing composite oxide represented by the following general composition formula (1):

Li_{1+y}MO₂ (1).

The general composition formula (1) satisfies −0.15≦y≦0.15. M represents an element group of three or more kinds, the element group at least including Ni, Co and Mn. Here, 25≦a≦90, 5≦b≦35, 5≦c≦35 and 10≦b+c≦70 are satisfied in which a, b and c represent ratios (mol %) of Ni, Co and Mn in the elements of M, respectively. In all of the positive electrode active material, a molar ratio of all Ni is 0.05 to 0.5 in all metals excluding Li. The negative electrode comprises a negative electrode mixture layer comprising a negative electrode active material comprising: a material including Si and O as constituent elements (wherein an atom ratio x of O to Si is 0.5≦x≦1.5. This material can be hereinafter referred to as “SiOₓ.”); and graphite carbon. The negative electrode mixture layer is provided on one side or both sides of a current collector. The non-aqueous electrolyte used in the lithium secondary battery comprises a halogen-substituted cyclic carbonate at a content of 0.5 to 5 mass %, when manufacturing the lithium secondary battery. The side part of the battery case includes two wide surfaces opposed to each other. The two wide surfaces are wider than the other surfaces in a side view thereof. The side part has such a cleavable groove that is cleaved when an internal pressure of the battery exceeds a threshold. The cleavable groove is provided at a portion to intersect with a diagonal of the wide surfaces in the side view.

As the third aspect of the present invention, there is provided a lithium secondary battery. The battery case is shaped in a hollow column. The battery case encloses a positive electrode a negative electrode, a non-aqueous electrolyte, and a separator. The positive electrode comprising a positive electrode mixture layer comprises a positive electrode active material, the positive electrode mixture layer provided on one side or both sides of a current collector. The positive electrode active material comprises a lithium-containing composite oxide comprising lithium and a transition metal, wherein at least a part of the lithium-containing composite oxide includes nickel as the transition metal. The negative electrode active material comprises a negative electrode mixture layer comprising: a composite of the material including Si and O as constituent elements (wherein an atom ratio x of O for Si is 0.5≦x≦1.5) with a carbon material; and a graphite carbon material. The negative electrode mixture layer is provided on one side or both sides of a current collector. A content of the composite of the material including Si and O as constituent elements with the carbon material is 1 to 20 mass % in the negative electrode active material. The non-aqueous electrolyte used in the lithium secondary battery includes a halogen-substituted cyclic carbonate at a content of 0.5 to 5 mass %, when manufacturing the lithium secondary battery. The side part of the battery case includes two wide surfaces opposed to each other. The two wide surfaces are wider than the other surfaces in a side view thereof. The side part has such a cleavable groove that is cleaved when an internal pressure of the battery exceeds a threshold. The cleavable groove is provided at a portion to intersect with a diagonal of the wide surfaces in the side view.

According to the first and second aspects of the present invention, a lithium secondary battery can be provided with a high capacity and excellent safety at an extreme high temperature.

According to the third aspect of the present invention, a lithium secondary battery can be provided with a high capacity, excellent in safety at an extreme high temperature, showing good storage characteristics.

According to the first to third aspects of the present invention, a lithium secondary battery can suppress the swelling, showing good charge discharge cycle characteristics.

### BRIEF DESCRIPTION OF THE DRAWINGS

FIG. 1 is a perspective view schematically illustrating an example of the lithium secondary battery of the present invention.

FIG. 2 is a side view of the lithium secondary battery of FIG. 1.

FIG. 3 is perspective view illustrating a state where the cleavable groove of the lithium secondary battery of FIG. 1 is cleaved.

FIG. 4 is a cross-sectional view at I-I line of FIG. 3.

FIG. 5 is a perspective view schematically illustrating another example of the appearance of the lithium secondary battery of the present invention.

FIG. 6 is a side view of the lithium secondary battery of FIG. 5.

FIG. 7 is a perspective view schematically illustrating another example of the appearance of the lithium secondary battery of the present invention.

FIG. 8 is a side view of the lithium secondary battery of FIG. 7.

FIG. 9 is a partial cross-sectional view schematically illustrating an example of the lithium secondary battery of the present invention.

FIG. 10 is a partial longitudinal cross-sectional view schematically illustrating the lithium secondary battery of Comparison Examples 2, 4, 6, and 13.

FIG. 11 is a perspective view schematically illustrating the appearance of the lithium secondary battery of Comparison Examples 2, 4, 6 and 13.

FIG. 12 is a side view schematically illustrating the appearance of the lithium secondary battery of Comparison Example 3, 7, and 15.

### EMBODIMENTS TO PRACTICE THE INVENTION

The lithium-containing composite oxide including Ni as transition metal has a high reactivity with a non-aqueous electrolyte. Here, it is concerned especially when the lithium secondary battery includes the lithium-containing composite oxide including Ni as transition metal serving as a positive electrode active material. In this case, when the battery is placed at an excessive high temperature in a charged condition, it might become in a state of thermal runaway such that the battery temperature is further raised. When a lithium secondary battery includes a lithium-containing composite oxide including Ni as transition metal serving as a positive electrode active material, the increase of the stop voltage in charging can expect to accomplish a battery capacity higher than a battery using LiCoO₂. However, in a condition of a higher voltage charged, it becomes more concerned of the thermal runaway, as explained here.

The first aspect of the lithium secondary battery of the present invention has the following characteristics. At least a part of the positive electrode active material includes a lithium-containing composite oxide including Ni as transition metal to accomplish a high capacity. Also, a cleavable groove is provided to accomplish a better vent operation than a conventional cleavable vent provided on a lid of a conventional lithium secondary battery. The cleavable groove of the present invention is provided at a specific location at the side part of the battery case to improve the safety under an excessive high temperature.

When the lithium-containing composite oxide including Ni is used in a lithium secondary battery as a positive electrode active material and is placed at excessive high temperature, it is concerned of the reactivity of the lithium-containing composite oxide. As a decomposition reaction of the non-aqueous electrolyte is progressed inside the battery, gases can be generated to immediately raise the battery internal pressure, which might cause explosion. These problems are more probable, for example, in combination with a high capacity material used as a negative electrode active material to make a higher capacity battery.

The second aspect of the lithium secondary battery of the present invention has the following features. SiOₓ, a high capacity material, in combination with graphite carbon material is used as a negative electrode active material. Also, instead of a conventional cleavable vent provided on a lid of a conventional lithium secondary battery, a specific cleavable groove is provided to improve a vent operation. This cleavable groove is provided at a location at the side part of the battery case. Furthermore, in the second aspect of the lithium secondary battery of the present invention, the battery capacity can be increased in view of the irreversible capacity by the specific combination of the positive electrode active material and the negative electrode active material. Also, the generated gases can be used to improve the vent operation of the cleavable groove when the battery is placed under excessive high temperature. In the second aspect of the lithium secondary battery of the present invention, these effects have accomplished the improvements in enhancing the high capacity and securing the safety placed under excessive high temperature.

Also, in the third aspect of the lithium secondary battery of the present invention, for the purpose to accomplish a higher capacity, a composite of SiOₓ and carbon material can be used with graphite carbon material, which can be used as a negative electrode active material. However, in case of a lithium secondary battery using such a negative electrode materials including SiOₓ, a volumetric change during the charge and the discharge makes the SiOₓ particles crushed, and thus, highly active Si is exposed to decompose the non-aqueous electrolyte. As a result, the charge discharge cycle characteristics are decreased.

In addition, when a battery is placed at excessive high temperature, a decomposition reaction of the non-aqueous electrolyte can be progressed inside a battery to promote the gas generation. Thus, it is concerned that the internal battery pressure is suddenly raised, which eventually results in explosion. This risk is more concerned when using a high capacity material such as SiOₓ as a negative electrode material to make a higher capacity battery.

Then, in the third aspect of the lithium secondary battery of the present invention, there can be the following features. First, a specific cleavable groove is provided to make a better vent operation than a conventional cleavable vent provided on a lid of a lithium secondary battery. The cleavable groove is provided at a specific location at the side part of the battery case. In addition, a non-aqueous electrolyte used in the lithium secondary battery includes a halogen-substituted cyclic carbonate at a specific content, when manufacturing the lithium secondary battery.

The halogen-substituted cyclic carbonate included in the non-aqueous electrolyte can provide a coating on the new surfaces made by crushing the SiOₓ particles during the charge and the discharge. As a result, the exposure of the high active Si can be avoided. Also, the charge discharge cycle characteristics of the battery can be improved. The inventors of the present invention have also discovered that a halogen-substituted cyclic carbonate generates gases when the battery is placed under excessive high temperature. This gas generation can accelerate the operation speed of the cleavable groove provided on the side part of the battery case.

Third aspect of the lithium secondary battery of the present invention is based on these discoveries. The halogen-substituted cyclic carbonates included in a non-aqueous electrolyte of a battery can generate gases to the extent that the vent operation of the cleavable groove can be improved. Also, the content of the non-aqueous electrolyte is adjusted not to impair the storage properties of the battery. As a result, a high capacity can be secured, while improving the safety at excessive high temperature and the storage characteristics.

Hereinafter, the present invention is explained with reference to the embodiments of the present invention. It is, however, noted that the embodiments here are examples. The scope of the invention should not be limited to the description here.

### <Positive Electrode>

The positive electrode of the lithium secondary battery of the present invention includes a positive electrode mixture layer containing a positive electrode active material, a binder and a conductive assistant. This positive electrode mixture layer is provided on one side or both sides of the current collector.

### <Positive Electrode Active Material>

The positive electrode active material of the lithium secondary battery of the present invention includes a lithium-containing composite oxide including lithium (Li) and transition metal.

The positive electrode active material of the first and the third embodiments of the lithium secondary battery of the present invention have the following features. The lithium-containing composite oxide includes Li and a transition metal. Here, at least a part of the lithium-containing composite oxide is a lithium-containing composite oxide including Ni as transition metal.

The lithium-containing composite oxide including Ni as transition metal includes at least Ni and Li. The examples of other transition metals included can be Co, Mn, titanium (Ti), chromic (Cr), iron (Fe), copper (Cu), silver (Ag), tantalum (Ta), niobium (Nb), and zirconium (Zr) can be included as a constituent element of the lithium-containing composite oxide. In addition, other element than the transition metal such as boron (B), phosphorus (P), zinc (Zn), aluminum (Al), calcium (Ca), strontium (Sr), barium (Ba), germanium (Ge), tin (Sn), and magnesium (Mg).

The lithium-containing composite oxide including Ni as transition metal has a capacity around the range of 3 to 4.4V (for Li), which is larger than that of the other lithium-containing composite oxides such as LiCoO₂. Therefore, this compound is advantageous to make a lithium secondary battery having a higher capacity. Therefore, for the purpose to obtain a higher capacity, the first embodiment of the lithium secondary battery of the present invention has the following features; the molar ratio of all Ni to all Li in all the positive electrode active material can be particularly 0.05 or more. From the same reasons, the third embodiment of the lithium secondary battery of the present invention has the following features; the molar ratio of all Ni to all Li in all the positive electrode active material can be particularly 0.05 or more.

The first embodiment of the lithium secondary battery of the present invention includes a positive electrode containing a specific positive electrode active material. Also, a specific cleavable groove is provided for a better vent operation than a conventional cleavable vent provided on a lid of a conventional lithium secondary battery. Furthermore, a separator with a high heat resistance is adopted. Therefore, an improved safety can be accomplished.

In addition, the third embodiment of the lithium secondary battery of the present invention includes a positive electrode containing a specific positive electrode active material. Also, a specific cleavable groove is provided to make a better vent operation than a conventional cleavable vent provided on a lid of a conventional lithium secondary battery. Furthermore, a specific non-aqueous electrolyte is used to make an improved operation of the cleavable groove. As a result, a high safety can be secured.

In the second embodiment, the positive electrode active material of the inventive lithium secondary battery is excellent in heat stability and stability in a potential condition. Therefore, the safety and other various battery properties can be improved to provide a lithium secondary battery. In addition, considering that the gas generation is less likely to be caused in a normal use environment of a battery, a specific lithium-containing composite oxide represented by the following general composition formula (1) can be used. Also in the first and the third embodiments of the inventive lithium secondary battery, for the same reasons as the second embodiment, a lithium-containing composite oxide including Ni as transition metal can be a lithium-containing composite oxide expressed by the following general composition formula (1).

Li_{1+y}MO₂ (1)

wherein the general composition formula (1) satisfies −0.15≦y≦0.15,
wherein M represents an element group of three or more kinds, the element group including at least Ni, Co and Mn, and
wherein 25≦a≦90, 5≦b≦35, 5≦c≦35 and 10≦b+c≦70 are satisfied in which a, b and c represent ratios (mol %) of Ni, Co and Mn in the element group of M, respectively.

In 100 mol % of the total element group M in the general composition formula (1) representing the lithium-containing composite oxide, the Ni ratio “a” can be particularly 25 mol % or more, and more particularly, 50 mol % or more, in view of obtaining an improved capacity of the lithium-containing composite oxide. However, when the Ni ratio is too large in the element group M, the quantities of e.g., Co and Mn can be decreased. Thus, in 100 mol % of the total element group M in the general composition formula (1) representing the lithium-containing composite oxide, the Ni ratio “a” can be particularly 90 mol % or less, and more particularly, 70 mol % or less.

Co contributes to a capacity of the lithium-containing composite oxide. Co increases the bulk density of the positive electrode mixture layer. On the other hand, if it is included excessively, it can increase the cost and deteriorate the safety. In 100 mol % of the total element group M in the general composition formula (1) representing the lithium-containing composite oxide, the Co ratio “b” can be, particularly, 5 mol % or more, and 35 mol % or less.

In 100 mol % of the total element group M in the general composition formula (1) representing the lithium-containing composite oxide, the Mn ratio “c” can be, particularly, 5 mol % or more, and 35 mol % or less. When Mn is incorporated in the lithium-containing composite oxide at the quantity specified here, Mn always exists in the crystal lattice. As a result, the thermal stability of the lithium-containing composite oxide can be improved to make a safer battery.

Furthermore, the inclusion of Co in the lithium-containing composite oxide can restrain Mn from changing its valence when Li is doped and de-doped during the charge and the discharge of the battery. In other words, an average valence value of Mn is stabilized at around 4. As a result, the reversibility of the charge and the discharge can be improved. Thus, the use of such a lithium-containing composite oxide can provide a battery excellent in the charge discharge cycle characteristics.

Also in view of securing above effects in incorporating Mn and Co, the lithium-containing composite oxide can be provided with the following features. Namely, in 100 mol % of the total element group M in the general composition formula (1) representing the lithium-containing composite oxide, the sum b+c (ratio b for Mn and ratio c for Co) can be, particularly, 10 mol % or more, and 70 mol % or less (in particular, 50 mol % or less).

The element group M in the general composition formula (1) representing the lithium-containing composite oxide can include other element than Ni, Co and Mn. For example, an element such as Ti, Cr, Fe, Cu, Zn, Al, Ge, Sn, Mg, Ag, Ta, Nb, B, P, Zr, Ca, Sr and Ba can be included. Note that in order to obtain the effects in incorporating Ni, Co and Mn in the lithium-containing composite oxide, the following features can be provided. Namely, in 100 mol % of the total element group M, and when the ratio of the element other than Ni, Co and Mn is expressed by f (mol %), the ratio f can be, particularly, 15 mol % or less, and more particularly, 3 mol % or less.

For example, the crystal structure of the lithium-containing composite oxide can be stabilized when Al exists in the crystal lattice of the lithium-containing composite oxide. Thereby, the thermal stability can be improved. The lithium secondary battery can be made safer. In addition, when Al exists on the grain boundaries and the surface of the lithium-containing composite oxide particles, its time-passage stability and side reactions with the electrolyte can be restrained. As a result, a lithium secondary battery with a long life can be obtained.

Note that Al does not participate in the charge discharge capacity. Therefore, a capacity can be decreased if the Al content is excessively included in the lithium-containing composite oxide. Therefore, in 100 mol % of the total element group M, a ratio of Al can be, particularly, 10 mol % or lower. On the other hand, in order to obtain the effects in incorporating Al, the ratio of Al can be, particularly, 0.02 mol % or more in 100 mol % of the total element group M.

The crystal structure of the lithium-containing composite oxide can be stabilized when Mg exists in the crystal lattice of the lithium-containing composite oxide. As a result, the thermal stability can be improved. Therefore, the lithium secondary battery can be made safer. In addition, it is noted that a phase transition of the lithium-containing composite oxide is caused by doping and de-doping Li when charging and discharging the lithium secondary battery. At this moment, an irreversible reaction can be suppressed since Mg can be transferred into the Li sites. As a result, the reversibility of the crystal structure of the lithium-containing composite oxide can be improved. Therefore, the lithium secondary battery having a long charge discharge cycle life can be obtained. Particularly when the general composition formula (1) of the lithium-containing composite oxide satisfies 1+y<0, the lithium-containing composite oxide has a crystal structure with a loss of Li. In this case, Mg takes the Li sites instead of Li to form a lithium-containing composite oxide, which becomes a stable compound.

It is, however, noted that Mg has a little participation in the charge discharge capacity. Therefore, a capacity might be decreased when its content is increased in the lithium component composition oxide. Thus, a ratio of Mg can be 10 mol % or lower in the general composition-type (1) representing the lithium component composition oxide, in 100 mol % of the total element group M. In addition, in order to effectively obtain the effects in incorporating Mg, the ratio of Mg in the general composition-type (1) representing the lithium containing composition oxide can be 0.02 mol % or more, in 100 mol % of the total element group M.

The inclusion of Ti in the lithium-containing composite oxide particles stabilizes the crystal structure as Ti is disposed in defective portions of the crystal such as oxygen deficiency in the LiNiO₂ crystal structure. Consequently, the reversibility of the reaction can be improved in the lithium-containing composite oxide, so that a lithium secondary battery can be provided with an improved charge discharge cycle characteristics. To ensure the effect resulting from Ti, the content of Ti can be 0.01 mol % or more, and in particular, 0.1 mol % or more, in 100 mol % of all of the element group M in the general composition formula (1) representing the lithium-containing composite oxide. On the other hand, when Ti is included at a large amount, the capacity can be decreased since Ti does not participate in the charge and the discharge, and also, the properties can be deteriorated due to the formation of a separate phase of Li₂TiO₃. Therefore, the content of Ti can be 10 mol % or less, and in particular, 5 mol % or less, and still in particular, 2 mol % or less, in 100 mol % of all of the element group M in the general composition formula (1) representing the lithium-containing composite oxide.

As the element group M in the general composition-type (1), when the lithium-containing composition oxide contains at least one kind of element M′ selected from the group consisting of Ge, Ca, Sr, Ba, B, Zr and Ga, the following effects can be obtained.

When the lithium-containing composite oxide contains Ge, the crystal structure of the compound oxide after Li is released can be stabilized. As a result, the reversibility of reaction during the charge and the discharge can be increased. Therefore, the lithium secondary battery can be made safer and excellent in view of the charge discharge cycle characteristics. Particularly when Ge exists at the particle surfaces and the grain boundaries of the lithium-containing composite oxide, the disorder of the crystal structure due to desorption of and insertion of Li at the interface can be restrained. As a result, the charge discharge cycle characteristics can be largely improved.

In addition, when the lithium-containing composite oxide contains alkaline earth metals such as Ca, Sr and Ba, the primary particles are grown to improve the crystallinity of the lithium-containing composite oxide. As a result, the number of the active spots can be reduced. Therefore, when this oxide is used to provide a paint (i.e., a composition including the positive electrode mixture composition as described later) to form a positive electrode mixture layer, the paint has an improved time-passage stability. Also, an irreversible reaction with the non-aqueous electrolyte of the lithium secondary battery can be restrained. Furthermore, since these elements exist in the particle surfaces and grain boundaries of the lithium-containing composite oxide, CO₂ gas inside the battery can be trapped. As a result, the lithium secondary battery becomes superior in the storage characteristics, having a long life. Particularly when the lithium-containing composite oxide contains Mn, the primary particles become hard to be grown up, so that the addition of alkaline earth metals such as Ca, Sr, and Ba can be useful.

When B is incorporated into the lithium-containing composite oxide, the growth of the primary particles can be promoted to improve the crystallinity of the lithium-containing composite oxide. Since the active spots can be reduced, the irreversible reactions with the atmospheric water, the binder in forming the positive electrode mixture layer, and the non-aqueous electrolyte of the battery can be restrained. Therefore, the time-passage stability of the paint to form the positive electrode mixture layer can be improved. Therefore, the gas generation in the battery can be suppressed. As a result, the lithium secondary battery can be superior in the storage characteristics with a long life. Particularly as for the lithium-containing composite oxide containing Mn, that is one of the lithium-containing composite oxides described above, the addition of B can be useful since the primary particles become hard to be grown up.

If the lithium-containing composite oxide contains Zr, the presence of Zr in the grain boundaries of and on the surface of the lithium-containing composite oxide particles can suppress the surface reactivity of the particles without impairing the electrochemical characteristics of the lithium-containing composite oxide, thereby accomplishing a lithium secondary battery having improved storage and long life properties.

When Ga is incorporated into the lithium-containing composite oxide, the growth of the primary particles can be promoted to improve the crystallinity of the lithium-containing composite oxide. Then, the active spots can be reduced, thereby improving the time-passage stability of the paint, which is used to form a positive electrode mixture layer. The irreversible reaction with the non-aqueous electrolyte can be restrained. In addition, due to the solid solution of Ga in the crystal structure of the lithium-containing composite oxide, the interlayer spacing of the crystal lattice can be expanded. As a result, the expansion-constriction ratio of the lattice due to the insertion of and desorption of Li can be reduced. Therefore, the reversibility of the crystal structure can be improved, thereby allowing the production of a lithium secondary battery with an improved charge discharge cycle life. Particularly when the lithium-containing composite oxide contains Mn, the addition of Ga is useful since the primary particles become hard to be grown up.

To efficiently obtain the effects by the element M′ selected from Ge, Ca, Sr, Ba, B, Zr or Ga, the element content of M′ in all of the element group M can be 0.1 mol % or more. Also, the element content of M′ in all the element group M can be 10 mol % or less.

The element other than Ni, Co and Mn in the element group M can be uniformly distributed in the lithium-containing composite oxide, or can be disproportionately distributed around the particle surfaces.

In the general composition formula (1) representing the lithium-containing composite oxide, a relation b>c can be satisfied between the ratio “b” for Co and the ratio “c” for Mn in the element group M, in which the particle growth of the lithium-containing composite oxide can be promoted. As a result, the bulk density of the positive electrode (or the positive electrode mixture layer) can be enhanced to provide a lithium-containing composite oxide with a higher reversibility. Therefore, the battery using such a positive electrode can improve the capacity.

On the other hand, when a relationship b≦c is satisfied between the ratio “b” for Co and the ratio “c” for Mn in the element group M in the general composition formula (1) representing the lithium-containing composite oxide, thermostability of the lithium-containing composite oxide can be enhanced. Therefore, the battery using such an oxide can improve safety.

The lithium-containing composite oxide having the composition as specified above has a true density of 4.55 to 4.95 g/cm³. This true density value is said to be large, which represents the material having a high volume energy density. It is noted that the true density of the lithium-containing composite oxide including Mn at a certain range is varied depending on the composition, but the structure made with such a narrow composition range above can be stabilized, thereby improving the uniformity. It is considered that the composition can be provided with a large true density that is close to LiCoO₂, for example. In addition, the capacity per mass of the lithium-containing composite oxide can be increased, and therefore, the material can become superior in reversibility.

The true density of the lithium-containing composite oxide increases especially when the composition of the lithium-containing composition oxide is close to stoichiometric proportions. Specifically, in the general composition formula (1), y can be satisfy −0.15≦y≦0.15. By adjusting y to have such a value, the true density can be increased and the reversibility can be improved. Also, y can be −0.05 or more and 0.05 or less. In this case, the lithium-containing composite oxide can have a high true density, e.g., a true density of 4.6 g/cm³ or more.

The composition analysis can be carried out for the lithium-containing composite oxide, which can be used as a positive electrode active material. The composition analysis can be carried out by an ICP (i.e., Inductive Coupled Plasma) method, as explained below. First, 0.2 g of the lithium-containing composite oxide of a target is collected, which is put into a 100 mL container. Then, pure water (5 mL), aqua regia (2 mL), and pure water (10 mL) are sequentially added and dissolved by heating. After cooling, the mixture is diluted by 25 times, which is then analyzed by the ICP (“ICP-757” made by JARREL ASH Corporation) (calibration curve method). Based on the results from this analysis, the composition formula of the lithium-containing composite oxide, as specified above, can be obtained.

The lithium-containing composite oxide represented by the general composition formula (1) can be prepared by the followings. A Li-containing compound (e.g., lithium hydroxide monohydrate), a Ni-containing compound (e.g., nickel sulfate), a Co-containing compound (e.g., cobalt sulfate), a Mn-containing compound (e.g., manganic sulfate) and compound(s) (e.g., aluminium sulfate, magnesium sulfate) containing other elements in the element group M are mixed together, which is then fired. In order to make the lithium-containing composite oxide a higher purity, a composite compound (e.g., hydroxides or oxides) containing plural elements belong to the element group M can be mixed with a Li-containing compound, and then fired.

The firing condition can be e.g., between 800 and 1050° C. for 1 to 24 hours. It is possible to first heat at a temperature (e.g., 250 to 850° C.), i.e., a lower temperature than the firing temperature, where the lower temperature is maintained for preheating; and second, to raise it to the temperature for firing. The duration of the preheating is not particularly limited, but it can be usually for 0.5 to 30 hours, for example. For example, the atmosphere during the firing can be in air atmosphere including oxygen (i.e., air atmosphere), a mixed atmosphere including an inert gas (e.g., argon, helium, nitrogen) and oxygen, and an oxygen gas atmosphere, where the oxygen concentration (by volume) can be 15% or more, and 18% or more.

In the first and third embodiments of the inventive lithium secondary battery, the positive electrode active material can be made of a lithium-containing composite oxide including Ni as transition metal. In particular, it can be made of a lithium-containing composite oxide represented by the general composition formula (1). It can be used alone or in combination.

In other words, the positive electrode active material of the first and third embodiments of the lithium secondary battery of the present invention can be a lithium-containing composite oxide including Ni as transition metal, alone. Alternatively, it can be the other lithium-containing composite oxide (e.g., lithium cobalt oxide such as LiCoO₂; lithium manganese oxide such as LiMnO₂, Li₂MnO₃, lithium-containing composite oxide with a spinel structure such as LiMn₂O₄, Li_{4/3}Ti_{5/3}O₄; lithium-containing composite oxide with an olivine structure such as LiFePO₄; and oxides of these compounds with various substitutions) in combination with the lithium-containing composite oxide including Ni as transition metal. In this case, one or more kinds of the lithium-containing composite oxides including Ni as transition metal can be used in combination with one or more kinds of the other lithium-containing oxides.

In addition, the first and third embodiments of the lithium secondary battery of the present invention can be provided with the following features. When the lithium-containing composite oxide including Ni as transition metal is used in combination with the other lithium-containing composite oxide, the content of the lithium-containing composite oxide including Ni as transition metal can be 10 mass % or more, and in particular, 30 mass % or more, in all the positive electrode active material. This is in view of effectively obtaining the effects of making a high capacity lithium secondary battery by using the lithium-containing composite oxide including Ni as transition metal. Also, in view of improving the storage properties under excessive high temperature of the lithium secondary battery, the content of the lithium-containing composite oxide including Ni as transition metal can be 80 mass % or less, and in particular, 60 mass % or less, in all the positive electrode active material.

In addition, the second embodiment of the lithium secondary battery of the present invention can be provided with the following features. The positive electrode active material can be made of a lithium-containing composite oxide expressed by the general composition formula (1), in which in all the positive electrode active material, the molar ratio of all Ni to all metal except for Li (hereinafter, it may be referred to as “Ni molar ratio”) can be 0.05 or more, and in particular, 0.1 or more. As a result, when the battery is placed under excessive high temperature, the gas generation amount inside the battery can be controlled in such a way that the cleavable groove on the battery case can be cleaved early. The cleavable groove will be later discussed in detail. As a result, the operation characteristics of the cleavable groove can be improved.

Also, the second embodiment of the inventive lithium secondary battery can be provided with the following feature. The molar ratio of all Ni to all metal except for Li in all the positive electrode active material can be 0.5 or lower, and in particular, 0.4 or lower.

In the second embodiment of the inventive lithium secondary battery, the SiOₓ used for the negative electrode has a high capacity while it has a large irreversible capacity. Therefore, during the first charge of the battery, Li (Li ions) released from the positive electrode active material is absorbed by the negative electrode, but relatively a large quantities of them are not released from the negative electrode at the time of discharge. In addition, the positive electrode active material expressed by the general composition formula (1), which is used in the second embodiment of the inventive lithium secondary battery, has a high capacity while it has a large irreversibility capacity as well. Even if all of Li (Li ions) released at the time of the initial charge of the battery is returned to the positive electrode at the time of discharge, relatively a large quantities of them cannot be incorporated.

In the second embodiment of the lithium secondary battery of the present invention, the lithium-containing composite oxide expressed by the general composition formula (1) is used as a positive electrode active material. In addition, SiOₓ together with graphite carbon material is used as a negative electrode active material. This configuration can accomplish the following features; the amounts of Li ions that the positive electrode active material releases and the negative electrode active material absorbs at the initial charge but that the negative electrode active material cannot release at the subsequent discharge can be corresponding to the amounts of Li ions that the positive electrode active material releases at the initial charge but that it cannot absorb even if all are returned to the positive electrode active material at the subsequent discharge. In other words, the irreversible capacity of the negative electrode active material is offset by the irreversible capacity of the positive electrode active material. Therefore, it is possible to obtain a higher capacity battery than merely using a high capacity positive electrode active material, or merely using a high capacity negative electrode active material. In addition, the adjustment into the specific molar ratio (i.e., a ratio lower than the specific lower value) of all Ni to all metal except for Li in all the positive electrode active material can make it more effective to offset the irreversible capacity of the negative electrode active materials by the irreversible capacity of the positive electrode active material.

The Ni molar ratio in all the positive electrode active material can be calculated by the following formula.

Σ(Nⱼ×aⱼ)/Σ(Mⱼ×aⱼ)

wherein in the formula, Nⱼ is a molar ratio of Ni included in ingredient j; aⱼ is a mass ratio of the ingredient j; and Mⱼ is a molar ratio of the metal except for Li in the ingredient j.

For example, if the lithium-containing composite oxide has the first ingredient: Li_{1.02}Ni_{0.6}Co_{0.2}Mn_{0.2}O₂; and the second ingredient: LiCoO₂ with the mass ratio of 1:1 (i.e., each mass ratio of the first and second ingredients is 0.5), the Ni molar ratio in all the positive electrode active material is calculated as follows:

(0.6×0.5+0×0.5)/{(0.6+0.2+0.2)×0.5+1.0×0.5}=0.3

In the second embodiment of the lithium secondary battery of the present invention, so long as the molar ratio of all Ni to all metal except for Li in all the positive electrode active material satisfies the specified value supra, the positive electrode active material can be alone of the lithium-containing composite oxide expressed by the general composition formula (1). Or, the positive electrode active material can be in combination of the other positive electrode active material together with the lithium-containing composite oxide expressed in the general composition formula (1). The other positive electrode active material, which can be used together with the lithium-containing composite oxide expressed in the general composition formula (1), can include: lithium cobalt oxide such as LiCoO₂; lithium manganese oxide such as LiMnO₂, and Li₂MnO₃; lithium nickel oxides such as LiNiO₂; lithium-containing composite oxide with a spinel structure such as LiMn₂O₄, Li_{4/3}Ti_{5/3}O₄; lithium-containing composite oxide with an olivine structure such as LiFePO₄; and oxides of these compounds with various substitutions. These compounds can be used alone or in combination.

In the second embodiment of the lithium secondary battery of the present invention, the positive electrode active material can be of the lithium-containing composite oxide expressed by the general composition formula (1) together with the other positive electrode active material. The other positive electrode active material can be of LiCoO₂ among the compounds as listed above. When using the lithium-containing composite oxide expressed by the general composition formula (1) in combination with the other positive electrode active material, it can be expected to effectively obtain the effects in using the lithium-containing composite oxide expressed by the general composition formula (1). In view of the above, the content of the lithium-containing composite oxide expressed by the general composition formula (1) can be 10 mass % or more in all the positive electrode active materials.

The average particle diameter of the positive electrode active material used in the present invention can be 5 μm or more, and particularly, 10 μm or more. It also can be 25 μm or less, and particularly, 20 μm or less. The particles of these positive electrode active materials can be of a secondary aggregate made of primary particles aggregated. In this case, the average particle diameter means the average particle diameter of the secondary aggregate.

The average particle diameters of the various particles described in the present specification (e.g., the lithium-containing composite oxide, or the fillers in the separator as described later) are measured by using a laser scatter particle size distribution calculator (e.g., “LA-920” manufactured by HORIBA, Ltd.). The particles are dispersed in a medium that doesn't dissolve the particles. As a result, an average particle diameter D_{50%} can be obtained.

Furthermore, to assure the reactivity with the lithium ions and to restrict a side reaction with the non-aqueous electrolyte, the particles of the positive electrode active material in the present invention can have a specific surface area of 0.1 to 0.4 m²/g measured by a BET method. The specific surface area of the lithium-containing composite oxide can be measured by the BET method by using a specific surface area measuring apparatus (“Macsorb HM modele-1201” manufactured by Mountech company) by means of the nitrogen adsorption process.

The lithium secondary battery of the present invention can be used with a constant-current constant-voltage charge with a stop voltage of about 4.2V in the same manner as conventional lithium secondary batteries including LiCoO₂ as a positive electrode active material. In addition, for the purpose to obtain a higher capacity, it can be applied to a constant-current constant-voltage charge with a stop voltage of 4.3V or more. Even if the battery in such a charged condition is placed under excessive high temperature environment, safety can be assured.

The content of the positive electrode active material (i.e., the total content of all the positive electrode active materials) can be 60 to 99 mass % in the positive electrode mixture layer.

### <Conductive Assistant for the Positive Electrode Mixture Layer>

A conductive assistant in the positive electrode mixture layer of the positive electrode of the inventive lithium secondary battery is not particularly limited as long as it is chemically stable in the lithium secondary battery. Examples of the conductive assistant include: graphites such as natural graphite and artificial graphite; carbon blacks such as acetylene black, ketjen black (trade name), channel black, furnace black, lamp black, and thermal black; conductive fibers such as carbon fiber and metal fiber; metal powders such as aluminum powder; fluorocarbon; zinc oxide; conductive whiskers made of potassium titanate and the like; conductive metal oxides such as titanium oxide; and organic conductive materials such as polyphenylene derivative. These materials can be used individually or in combinations of two or more. Among these materials, graphites and carbon blacks can be particularly used because graphites have high conductivity and carbon blacks have excellent liquid absorbency. Further, the conductive assistant is not limited to the form of primary particles, and can be in a form of aggregates such as a secondary aggregate or chain structure. The conductive assistant in the form of aggregates is easy to handle and can improve the productivity.

Moreover, the positive electrode mixture layer of the positive electrode of the lithium secondary battery according to the present invention can include carbon fibers with an average fiber length of 10 nm or more, and less than 1000 nm, and an average fiber diameter of 1 nm or more, and 100 nm or less, at an amount of 0.25 mass % or more, and 1.5 mass % or less. When including such carbon fibers with an average fiber length of 10 nm or more, and less than 1000 nm, and an average fiber diameter of 1 nm or more, and 100 nm or less, at an amount of 0.25 mass % or more, and 1.5 mass % or less, a density growth of the positive electrode mixture layer can be accomplished. Therefore, a high capacity battery can be accomplished.

Moreover, the battery swelling due to gas formation can be suppressed. The load characteristic and the electrical charge discharge cycle characteristics of the battery can be improved by suppressing the reaction between the positive electrode and the non-aqueous electrolyte when using the lithium-containing composite oxide including Ni as transition metal together with the carbon fibers.

The details of the reasons are unclear as to why the use of carbon fiber can contribute to the density growth of the positive electrode mixture layer, suppressing the reaction between the positive electrode and the non-aqueous electrolyte, and improving the load characteristic and the charge discharge cycle characteristics of the battery. However, as to the density growth of the positive electrode mixture layer, it is considered that the carbon fibers with the size as mentioned above can be excellently distributed, in particular, to make such a structure that the surface of the lithium-containing composite oxide is coated with carbon fibers. Also, inclusion of a lot of fibers with a short fiber length makes the positive electrode active material particles closer to each other, thereby efficiently filling the elements of the positive electrode mixture layer.

Moreover, the carbon fibers (i.e., the conductive assistant) can be dispersed excellently such that the reaction can be leveled over the entire of the positive electrode mixture layer. Thus, the area of the positive electrode mixture layer that can be actually involved in the reaction can be increased, thereby improving the load characteristics. Furthermore, the local reaction of the positive electrode mixture layer can be suppressed as well as the deterioration of the positive electrode can be suppressed when repeating the charge and the discharge. Therefore, the charge discharge cycle characteristics can be improved. Also, the reactivity with the non-aqueous electrolyte can be controlled to suppress the gas formation.

The average fiber length of the carbon fiber can be 30 nm or more, and can be 500 nm or less. In addition, the average fiber diameter of the carbon fiber can be 3 nm or more, and can be 50 nm or less.

It is noted that the average fiber length and the average fiber diameter of the carbon fiber described in the present specification can be obtained by the measurements using a transmission electron microscope (TEM such as “JEM series” made by JEOL Ltd., and “H-700H” made by Hitachi Ltd.) under the condition of an acceleration voltage of 100 or 200 kV to take TEM images. Setting at 20,000-40,000 times magnification when analyzing the average fiber length, or setting at 200,000-400,000 magnification when analyzing the average fiber diameter, the TEM images of 100 samples are taken. A steel ruler certified as the first grade according to the JIS is used to measure the length and the diameter of each sample. The results are averaged to obtain the average fiber length and the average fiber diameter.

The positive electrode mixture layer according to the present invention can include carbon fibers with an average fiber diameter of 10 nm or more, and less than 1000 nm, and an average fiber length of 1 nm or more, and 100 nm or less, in combination of the graphite as mentioned before. In this case, the dispersibility of the carbon fiber in the positive electrode mixture layer can be more excellent. Therefore, it becomes possible to improve the load characteristics and the charge discharge cycle characteristics of the lithium secondary battery.

When using graphite together with carbon fiber, in 100 mass % of the total contents of carbon fiber and graphite included in the positive electrode mixture layer, the content of graphite can be 25 mass % or more. As a result, the effects by using graphite together with carbon fiber can be more excellent. It is noted that when the amount of graphite in the total amounts of carbon fiber and graphite in the positive electrode mixture layer is excessively increased, the amount of the conductive assistant will be excessively increased. As a result, the filling amount of the positive electrode active material will be decreased, thereby impairing the effects of a high capacity. Therefore, in 100 mass % of the total contents of carbon fiber and graphite included in the positive electrode mixture layer, the content of graphite can be 87.5 mass % or less.

Moreover, as a conductive assistant of the positive electrode mixture layer, when using carbon fiber in combination with the other conductive assistant (hereinafter, which is referred to as “the other conductive assistant”) than the above-mentioned carbon fiber and graphite, the content of the other conductive assistant can be 25 to 87.5 mass % in 100 mass % of the total contents of the carbon fiber and the other conductive assistant included in the positive electrode mixture layer.

The content of the conductive assistant (i.e., the total content of all the conductive assistants) in the positive electrode mixture layer can be 1 to 10 mass %.

### <Binder in Positive Electrode Combination Medicine Layer>

As the binder included in the positive electrode mixture layer of the positive electrode of the lithium secondary battery according to the present invention, either a thermoplastic resin or a thermosetting resin can be used so long as it is chemically stable inside the lithium secondary battery. Examples of the binder include: polyethylene; polypropylene; vinylidene fluoride polymer made mainly from a monomer of vinylidene fluoride such as polyvinylidene fluoride (PVDF); polytetrafluoroethylene (PTFE); polyhexafluoropropylene (PHFP); styrene-butadiene rubber; tetrafluoroethylene-vinilidene fluoride copolymer (P(TFE-VDF); tetrafluoroethylene-hexafluoroethylene copolymer; tetrafluoroethylene-hexafluoropropylene copolymer (FEP); tetrafluoroethylene-perfluoroalkylvinyl ether copolymer (PFA); ethylene-tetrafluoroethylene copolymer (ETFE); polychlorotrifluoroethylene (PCTFE); propylene-tetrafluoroethylene copolymer; ethylene-chlorotrifluoroethylene copolymer (ECTFE); and ethylene-acrylic acid copolymer; ethylene-methacrylic acid copolymer; ethylene-methyl acrylate copolymer; ethylene-methyl methacrylate copolymer; and an Na ion crosslinked body of these copolymers. These materials can be used individually or in combinations of two or more.

Among these binders, P(TFE-VDF) polymer and VDF polymer (the VDF polymer is different from the P(TFE-VDF)) can be used.

A VDF polymer including PVDF is relatively usually used as a binder for the positive electrode mixture layer of lithium secondary batteries. In a positive electrode including the positive electrode active material of the lithium-containing composite oxide including Ni as transition metal, use of VDF polymer as a binder can cause crosslinking reaction of the VDF polymer. Therefore, the adhesion of the positive electrode mixture layer and the collector becomes excessively high. When producing a rolled electrode body using such a positive electrode together with a negative electrode and a separator, the defects such as cracks can be often caused especially at the inner side of the positive electrode mixture layer. However, when using P(TFE-VDF) together with VDF polymer as a binder of the positive electrode mixture layer, P(TFE-VDF) can exhibit the effects to adequately reduce the adhesion between the positive electrode mixture layer and the collector. As a result, the defects at the positive electrode mixture layer can be excellently suppressed.

The content of the binder in the positive electrode mixture layer (when several kinds of binders are used, the “content” means the total content of all the binders.) can be 4 mass % or less and in particular, 3 mass % or less. If excessively included, the adhesion between the positive electrode mixture layer and the collector becomes too high, thereby causing the problems as explained before.

On the other hand, for the purpose to increase the capacity of the positive electrode, it is possible to decrease the amount of the binder in the positive electrode mixture layer while to increase the amount of the positive electrode active material. However, if the amount of the binder in the positive electrode mixture layer is too little, the flexibility of the positive electrode mixture layer can be impaired. As a result, for example, the shape of the rolled electrode body using such a positive electrode is deteriorated (especially, as to the shape of the outer side). Therefore, the productivity of the positive electrode as well as the productivity of the battery can be impaired. Thus, the content of the binder in the positive electrode mixture layer can be 1 mass % or more, and in particular, 1.2 mass % or more.

Also, when using VDF polymer together with P(TFE-VDF) as a binder of the positive electrode mixture layer, assuming that these totals are 100 mass %, the content of P(TFE-VDF) can be 10 mass % or more, and in particular, 20 mass % or more. As a result, the adhesion with the collector can be appropriately suppressed in preparing the positive electrode mixture layer including the lithium-containing composite oxide including Ni as transition metal and VDF polymer.

However, in the combination of P(TFE-VDF) and VDF polymer, when the amount of P(TFE-VDF) is too large, the adhesion strength between the positive electrode mixture layer and the collector can be decreased, and the battery resistance is increased. As a result, the load characteristic of the battery can be decreased. Therefore, in 100 mass % of the total content of P(TFE-VDF) and VDF polymer in the positive electrode mixture layer, the content of P(TFE-VDF) can be 30 mass % or lower.

### <Positive Electrode Mixture Layer and Collector, Etc.>

The positive electrode can be made as follows. For example, the positive electrode active material, the binder and the conductive assistant, as explained above, are dispersed into a solvent such as N-methyl-2-pyrrolidone (NMP) to prepare a composition in a state of paste or slurry including the positive electrode mixture components. Note that the binder can be dissolved in a solvent. This composition is applied to one side or both sides of a current collector. After drying, a calendar process is carried out, if necessary, to obtain a positive electrode. However, the method for manufacturing the positive electrode is not particularly limited to the description here. Other methods can be used.

The positive electrode mixture layer can have a thickness of 15 to 200 μm per one side of the current collector after the pressing. Furthermore, the positive electrode mixture layer can have a density of 3.2 g/cm³ or more, and in particular, 3.6 g/cm³ or more after the pressing. It is possible to further increase the capacity if the electrode is produced to have the positive electrode mixture layer having such a high density. However, if the density of the positive electrode mixture layer is too large, the porosity declines, so that the non-aqueous electrolyte permeability can be deteriorated. Therefore, the positive electrode mixture layer can have a density of 4.2 g/cm³ or less after the calendar pressing. For the calendar pressing, the positive electrode mixture layer can be applied to a roll press at a linear pressure of about 1 to 30 kN/cm, for example. Such a process allows the positive electrode mixture layer to have the density as described above.

The density of the positive electrode mixture layer in the context of the present specification is a value measured as follows. The positive electrode is cut into a sample having a certain area, and the mass of the sample is measured by an electronic force balance with a minimum scale of 0.1 mg. Then, the mass of the current collector is subtracted from the mass of the sample, yielding the mass of the positive electrode mixture layer. On the other hand, the total thickness of the positive electrode is measured at 10 points by a micrometer with a minimum scale of 1 μm, and the volume of the positive electrode mixture layer is calculated from the area and the average of the values obtained by subtracting the thickness of the current collector from the measured values. The density of the positive electrode mixture layer is then determined by dividing the mass by the volume of the positive electrode mixture layer.

As the current collector of the positive electrode, the same or similar current collector can be used as conventionally known for the positive electrode of the lithium secondary batteries. For instance, an aluminum foil with a thickness of 10 to 30 μm can be used.

### <Negative Electrode>

The negative electrode used in the lithium secondary battery of the present invention has a structure in which a negative electrode mixture layer containing negative electrode active materials, a binder, and the like, is formed on one side or both sides of a current collector.

The negative electrode active material can be graphite carbon materials (*), thermolysis carbons; cokes; glassy carbons; and a burned body of organic polymer compounds, mesocarbon microbeadses, carbon fibers, activated carbons, a lithium-alloyable metal (e.g., Si and Sn) or its alloy or oxides. Here, the graphite carbon materials (*) can be natural graphite such as scale-like graphite; or artificial graphite obtained from easily-graphitizable carbon, such as thermolysis graphite, mesophase carbon microbeads (MCMB) and carbon fibers, subjected to a graphitizing treatment at 2800° C. or more.

The second embodiment and the third embodiment of the lithium secondary battery of the present invention can be provided with the following features. Namely, as a negative electrode active material, a graphite carbon material can be used in combination with SiOₓ. Also in the first embodiment of the lithium secondary battery of the present invention, SiOₓ together with a graphite carbon material can be used as a negative electrode active material in view of accomplishing a higher capacity.

Furthermore, SiOₓ is not limited to a Si oxide and can include a Si microcrystalline phase or Si amorphous phase. In this case, the atomic ratio of Si and O is a ratio calculated by including the Si microcrystalline phase or Si amorphous phase. In other words, materials represented by SiOₓ include those having a structure in which Si (e.g., microcrystalline Si) is dispersed in an amorphous SiO₂ matrix. In this case, the atomic ratio x, including amorphous SiO₂ and Si dispersed in the amorphous SiO₂, can satisfy 0.5≦x≦1.5. For example, in the case of a material having a structure in which Si is dispersed in an amorphous SiO₂ matrix and a molar ratio of SiO₂ to Si is 1:1, x is equal to 1 (x=1). Hence, this material is referred to as SiO in the present invention. When a material having such a structure is analyzed by, for example, X-ray diffractometry, a peak resulting from the presence of Si (microcrystalline Si) might not be observed. However, when the material is observed under a transmission electron microscope, the presence of impalpable Si can be found.

In the third embodiment of the lithium secondary battery of the present invention, it is possible to use a composite of SiOₓ with carbon material. For example, the surface of SiOₓ can be coated with carbon material. Also in the second embodiment of the lithium secondary battery of the present invention, it is possible to use a composite of SiOₓ with carbon material. For example, the surface of SiOₓ can be coated with carbon material. Also in the first embodiment of the lithium secondary battery of the present invention when SiOₓ is used as a negative electrode, it is possible to use a composite of SiOₓ with carbon material. For example, the surface of SiOₓ can be coated with carbon material.

SiOₓ has a poor conductivity. When it is used as a negative electrode active material, it is necessary to use a conductive material (conductive assistant) in light of obtaining excellent battery characteristics. Therefore, by means of good mixture and dispersion of SiOₓ with the conductive material in the negative electrode, an excellent conductive network should be formed. A composite of SiOₓ with carbon material can form a better conductive network in the negative electrode than using a material made of merely mixing the conductive material such as carbon material with SiOₓ.

The composite of SiOₓ with carbon material can have surfaces of SiOₓ coated with carbon material. In addition, the granules of SiOₓ and the carbon material can be exemplified.

Also, the composite having the SiOₓ surfaces coated with carbon material can be modified into another composite with another conductive material (e.g., carbon material). As a result, more advantageous conductive network can be formed in the negative electrode, attaining a lithium secondary battery with a higher capacity and more excellence regarding the battery characteristics (e.g., charge discharge cycle characteristics). The following can be an example of such a modified composite including another carbon material in combination with the compound of SiOₓ covered with carbon material. Namely, such an example can be granules obtained by granulating a mixture of the composite of SiOₓ coated with carbon material in combination with another carbon material.

As the SiOₓ whose surface is coated with carbon material, the following composite can be also used. Such a composite has a surface of a SiOₓ-carbon material composite (e.g., granules; the carbon material has a smaller specific resistance than the SiOₓ) coated with another carbon material. When the SiOₓ and the carbon material are dispersed within the granules, more advantageous conductive network can be formed. Therefore, it is possible to further improve the lithium secondary battery using the negative electrode containing the SiOₓ as a negative electrode active material, in view of the battery characteristics such as heavy load discharge characteristics.

The examples of carbon materials used to form a composite with the SiOₓ can include carbon materials such as low crystalline carbon, carbon nanotube, and vapor-grown carbon fiber.

In more detail, the carbon material can be at least one material selected from the group as follows: a fibrous or coil-shaped carbon material, carbon black (including acetylene black and ketjen black), artificial graphite, easily graphitizable carbon, and hardly graphitizable carbon. A fibrous or coil-shaped carbon material can be used because it facilitates the formation of a conductive network and has a large surface area. Carbon black (including acetylene black and ketjen black), easily graphitizable carbon and hardly graphitizable carbon can be used because they have high electrical conductivity and high liquid-holding ability, and moreover they have the property of readily maintaining contact with the SiOₓ particles even if the particles expand and/or shrink.

The carbon material can be graphite carbon material used as a negative electrode active material along with the SiOₓ. Like carbon black, graphite carbon material also has high electrical conductivity and liquid-holding ability, and moreover it has the property of readily maintaining contact with the particles of the SiOₓ even if the particles expand and/or shrink. Thus, it can be used to form a composite with the SiOₓ.

Among the carbon materials described above, fibrous carbon material can be used to form a composite with the SiOₓ in the form of granules. Since a fibrous carbon material has a thin thready shape and is highly flexible, it can respond to expansion and/or shrinkage of the SiOₓ associated with charging/discharging of the battery. Also, the fibrous carbon material has a large bulk density, so that it can have many contacts with the SiOₓ particles. The examples of the fibrous carbon can include polyacrylonitrile (PAN) carbon fiber, pitch carbon fiber, vapor-grown carbon fiber, and carbon nanotube, and any of these materials can be used.

It is also possible to form the fibrous carbon material on the surface of the SiOₓ particles by, for example, vapor phase method.

SiOₓ generally has a specific resistance of 10³ to 10⁷ kΩcm, whereas the carbon materials described above can have a specific resistance of 10⁻⁵ to 10 kΩcm. Further, the composite of SiOₓ and carbon material can be further provided with a material layer (material layer containing hardly graphitizable carbon) covering the carbon material coating layer on the particle surface.

When using the SiOₓ-carbon material composite in the negative electrode, the ratio of the carbon material to the SiOₓ can be 5 parts by mass or more, and in particular, 10 parts by mass or more carbon material to 100 parts by mass of SiOₓ. As a result, it is possible to exhibite the effects resulting from combining the SiOₓ with the carbon material. If the carbon material combined with the SiOₓ makes up an excessively large proportion of the composite, it may lead to a decline of the amount of the SiOₓ contained in the negative electrode mixture layer, thereby impairing the effect of increasing the capacity. For this reason, the ratio of the carbon material to the SiOₓ can be 50 parts by mass or less, and in particular, 40 parts by mass or less carbon material to 100 parts by mass of SiOₓ.

For example, the SiOₓ-carbon material composite can be obtained as follows.

First, a method for producing a composite of the SiOₓ is described. A dispersion liquid is prepared in which the SiOₓ are dispersed in a dispersion medium. Then, the dispersion liquid is sprayed and dried to produce composite particles composed of a plurality of particles. For example, ethanol can be used as the dispersion medium. It can be suitable to spray the dispersion liquid in e.g., a 50 to 300° C. atmosphere. Other than the method described here, a mechanical granulation method using a vibration or planetary ball mill or a rod mill can be used to obtain the composite particles in a similar way.

When producing granules of SiOₓ and a carbon material having a smaller specific resistance than the SiOₓ, the carbon material is added to a dispersion liquid of the SiOₓ dispersed in a dispersion medium. Using this dispersion liquid, the composite particles (granules) can be produced in the same way as combining the SiOₓ. Also, the SiOₓ-carbon material granules can be produced by the same way as the mechanical granulation described above.

Next, when producing a composite by coating the surface of SiOₓ particles (SiOₓ composite particles, or SiOₓ-carbon material granules) with a carbon material, the SiOₓ particles and hydrocarbon gas are heated in a vapor phase to deposit carbon generated by the thermal decomposition of the hydrocarbon gas on the surface of the particles. In this way, the hydrocarbon gas can be distributed throughout the composite particles by chemical-vapor deposition (CVD), so that a thin and uniform coating containing the conductive carbon material (i.e., carbon material coating layer) can be formed on the surface of the particles and holes on its surface. Thus, conductivity can be imparted to the SiOₓ particles uniformly by using a small amount of carbon material.

The treatment temperature (atmospheric temperature) of the chemical-vapor deposition (CVD) varies depending on the type of hydrocarbon gas used, but 600 to 1200° C. is suitable. In particular, the treatment temperature can be 700° C. or more, and in particular, 800° C. or more. As a result, a higher treatment temperature leads to lesser residual impurities and allows the formation of the coating layer containing highly conductive carbon.

While toluene, benzene, xylene, mesitylene or the like can be used as a liquid source of the hydrocarbon gas, toluene can be particularly used because it is easy to handle. The hydrocarbon gas can be obtained by evaporating (e.g., bubbling with nitrogen gas) any of these kinds of the liquid source. It is also possible to use methane gas, acetylene gas, and the like.

After coating the surface of the SiOₓ particles (SiOₓ composite particles, or the SiOₓ-carbon material granules) with the carbon material by chemical-vapor deposition (CVD), at least one organic compound selected from the group consisting of petroleum pitch, coal pitch, thermosetting resin, and a condensation product of naphthalene sulfonate and aldehydes is adhered to the coating layer containing the carbon material, and then the particles to which the organic compound is adhered can be fired.

In detail, a dispersion liquid is prepared in which an organic compound and SiOₓ particles having coated with carbon material (SiOₓ composite particles, or the SiOₓ-carbon material granules) are dispersed in a dispersion medium. Then, the dispersion liquid is sprayed and dried to form particles having coated with the organic compound. Then, the particles having coated with the organic compound are fired.

The pitch can be an isotropic pitch. The thermosetting resin can be phenol resin, furan resin, furfural resin or the like. The condensation product of naphthalene sulfonate and aldehydes can be a naphthalene sulfonate-formaldehyde condensation product.

The dispersion medium can be water or alcohols (e.g., ethanol) for dispersing the organic compound and the SiOₓ particles having its surface coated with the carbon material. The dispersion liquid can be usually sprayed in an atmosphere at a temperature of 50 to 300° C. The appropriate temperature of the firing can be 600 to 1200° C. Among the range above, it can be suitable at 700° C. or more, and in particular at 800° C. or more. A higher treatment temperature can lead to lesser residual impurities, thereby forming the coating layer containing excellent carbon material with a high conductivity. However, the treatment temperature is required to be lower than or equal to the melting point of

The composite of SiOₓ and carbon material (especially, it is a composite of SiOₓ coated with carbon material) can have the following features. Namely, when conducting a Raman spectrometry using a measurement laser with a wavelength of 532 nm, the resulting Raman spectrum has a ratio I₅₁₀/I₁₃₄₃ of 0.25 or less. Here, I₅₁₀ is the peak strength at the peak in the vicinity of 510 cm⁻¹ which belongs to Si, and I₁₃₄₃ is the peak strength at the peak in the vicinity of 1343 cm⁻¹ which belongs to the carbon material as mentioned above.

More specifically, I₅₁₀/I₁₃₄₃ is obtained by a microscopic Raman spectroscopy. Conducting mapping measurements of the composite (at a range of 80×80 μm and with a step of 2 μm), all the spectra measured within the range are averaged, thereby obtaining each strength of the Si peak (around 510 cm⁻¹) and the carbon (C) peak (around 1343 cm⁻¹). Then, I₅₁₀/I₁₃₄₃ is calculated from these peaks.

When the composite of SiOₓ with carbon material satisfies the value of I₅₁₀/I₁₃₄₃ specified above, the following features can be found. In this condition, among the SiOₓ particle surfaces, the ratio of the portion not coated with carbon material (in other words, the portion where the surfaces of the SiOₓ particles are exposed) is comparatively small. Therefore, the conductivity improvement effect can be remarkably exhibited in using SiOₓ in combination with carbon material. Therefore, the condition (*) can be adjusted in such a way that the I₅₁₀/I₁₃₄₃ value satisfies the above-mentioned range during the production of the composite of SiOx and carbon material. For example in case of the CVD method, the condition (*) above can include the treatment temperature, the processing time, and the concentration of the liquid source for the carbon material in the processing environment.

The following features can be provided with the composite of SiOₓ and carbon material, and especially the composite of SiOₓ having coated with carbon material by means of a CVD method. Namely, the half width at the diffraction peak at the Si (111) face obtained in the X-ray diffraction analysis using CuK αbeam is 0.5 to 2.5°. When the crystallinity of Si in the composite is adjusted into the range above, the capacity can be maintained higher. In other words, when the half width is too little, the capacity may be decreased. Also, when the half width is too large, the capacity of the lithium secondary battery after storage might be decreased.

The half width at the diffraction peak at the Si (111) face in the composite of SiOₓ and carbon material can be provided with the following features. Namely, the half width can be controlled by adjusting the treatment temperature in manufacturing through the CVD method, for example. Generally, the half width becomes low when the treatment temperature is raised, whereas the half width becomes high when the treatment temperature is decreased.

As a negative electrode active material, it is possible to use graphite carbon material together with SiOₓ (in particular, it is a composite of SiOₓ and carbon material). SiOₓ has a capacity higher than carbon material which is widely used as a negative electrode active material of lithium secondary batteries. On the other hand, SiOₓ has a large volume change amount during the charge and the discharge of the battery. Therefore, if a lithium secondary battery uses a negative electrode with a negative electrode mixture layer including SiOₓ at a high content, repetition of the charge and the discharge can largely change the volume of the negative electrode (or, the negative electrode mixture layer), thereby decreasing the capacity. (Namely, it is possible that the charge discharge cycle characteristics can be impaired.) The graphite carbon material is widely used as a negative electrode active material of lithium secondary batteries, and the capacity is comparatively large, while the amount of the volume change due to charge and discharge of the battery is smaller than that of SiOₓ. Therefore, a combination of SiOₓ and graphite carbon material used as a negative electrode active material can suppress the tendency to decrease the capacity improvement effects when reducing the amount of SiOₓ used. Moreover, the deterioration of the charge discharge cycle characteristics of the battery can be suppressed excellently. As a result, a lithium secondary battery can be provided with a high capacity and excellent charge discharge cycle characteristics.

The examples of the graphite carbon material used as a negative electrode active material along with the SiOₓ-carbon material composite include: natural graphite such as scaly graphite; and artificial graphite obtained by graphitizing easily graphitizable carbons, such as pyrolytic carbons, mesocarbon microbeads (MCMB) and carbon fiber, at 2800° C. or more.

When the composite of SiOₓ and carbon material is used in combination with graphite carbon material as a negative electrode active material, there can be found the following features. Namely, a high capacity can be obtained by using SiOₓ. Also, such a high capacity can be excellently maintained by offsetting the irreversible capacity of the negative electrode active material and the irreversible capacity for the above-mentioned specific positive electrode active material. In view of the above, the content of the composite of SiOₓ and carbon material in all the negative electrode active materials can be 0.01 mass % of more, and in particular, 1 mass % or more, and more in particular, 3 mass % or more. On the other hand, it can be also considered to avoid the problems associated with the volumetric change of SiOₓ during the charge and the discharge. In view of the above, the content of the composite of SiOₓ and the carbon material in all the negative electrode active materials can be 20 mass % or less, and in particular, 15 mass % or less.

The negative electrode containing SiOₓ has a larger amount of the volumetric change associated with the charge and the discharge than that of a negative electrode including carbon material such as graphite alone as negative electrode active material. Therefore, especially when forming a rolled electrode body in which the electrode body of the battery is wound in a winding shape, waves can be formed in the thickness direction of the battery as using the battery, thereby generating spaces in the electrode body. The spaces in the electrode body can be formed along the direction of the winding axis. In particular, they can be formed at the portions near the center part in the width direction, when seeing the side view from the side of the wide surface of the battery. As a result, in the lithium secondary battery of the present invention, gases can be generated in the battery when placed under excessive high temperature, accumulating at the space of the electrode body. Thus, the portions near the spaces in the battery case can be swollen more than the other parts. Therefore, when the lithium secondary battery according to the present invention is placed under excessive high temperature, the existence of SiOₓ can make the battery case locally swollen more than a battery when using carbon material alone as a negative electrode active material. This effect can promote the operation of the cleavable groove provided at a specific part on the battery case, thereby improving the safety.

In the negative electrode mixture layer, that the total amount of the negative electrode active materials (total of the SiOₓ-carbon material composite and the graphite carbon material) can be 80 to 99 mass %.

### <Binder for the Negative Electrode Mixture Layer>

The examples of the binder used in the negative electrode mixture layer include: polysaccharides such as starch, polyvinyl alcohol, polyacrylic acid, carboxymethyl cellulose (CMC), hydroxypropyl cellulose, regenerated cellulose and diacetyl cellulose and modified products thereof; thermoplastic resins such as polyvinyl chloride, polyvinyl pyrrolidone, polytetrafluoroethylene, polyvinylidene fluoride, polyethylene, polypropylene, polyamideimide, and polyamide and modified products thereof; polyimide; elastically resilient polymers such as ethylene-propylene-dieneter polymer (EPDM), sulfonated EPDM, styrene butadiene rubber (SBR), butadiene rubber, polybutadiene, fluorocarbon rubber and polyethylene oxide and modified products thereof. These materials can be used individually or in combination of two or more.

The content of the binder (i.e., the total content of all the binders) in the negative electrode mixture layer can be 1 to 20 mass %.

### <The Conductive Assistant of the Negative Electrode Mixture Layer>

A conductive material can further be added to the negative electrode mixture layer as a conductive assistant. Such a conductive material is not particularly limited as long as it does not chemically react in the lithium secondary battery. Materials such as carbon black (e.g., thermal black, furnace black, channel black, ketjen black, and acetylene black), carbon fiber, metal powders (e.g., powders of copper, nickel, aluminum, and silver), metal fiber, polyphenylene derivative (the one described in JP S59-20971 A) can be used individually or in combination of two or more. Among these materials, it is possible to use carbon black, and in particular, ketjen black or acetylene black.

A carbon material used as a conductive assistant can have a particle diameter as follows. For example, the average particle diameter can be measured by a method similar to the way to measure the average fiber length as described before. Alternatively, the average particle diameter can be measured by using a laser scatter particle size distribution calculator (made of the HORIBA, Ltd. “LA-920,” for example), where the fine particles are dispersed in the medium to obtain an average particle diameter (D50%). The average particle diameter can be 0.01 μm or more, and particularly, 0.02 μm or more, while it can be 10 μm or less, and particularly, 5 μm or less.

When the negative electrode mixture layer contains a conductive material as a conductive assistant, the contents of the negative electrode active material and the binder can satisfy the ranges as specified above.

### <Negative Electrode Mixture Layer and Current Collector, Etc.>

The negative electrode can be manufactured as follows. For example, the negative electrode active material and the binder, and the conductive assistant if necessary, are dispersed in a solvent such as NMP and water to obtain a negative electrode component containing composition in a state of paste or slurry. (It is noted that the binder can be dissolved in the solvent.) Next, the negative electrode component containing composition is applied on one side or both sides of a current collector. After dried, a calendar process is applied, if necessary, to obtain a negative electrode. It is noted that the method for manufacturing the negative electrode is not limited to the description here. Other methods can be used. The thickness of the negative electrode mixture layer can be 10 to 100 μm for each one side of the current collector.

As the negative electrode current collector, a metal foil, punched metal, metal mesh, expanded metal or the like made of copper or nickel can be used. For example, a copper foil can be used. When reducing the thickness of the negative electrode as a whole to achieve a battery with a high energy density, an upper limit of the thickness of the negative electrode current collector can be 30 μm and a lower limit of the thickness of the negative electrode current collector can be 5 μm in order to ensure the mechanical strength.

### <Non-Aqueous Electrolyte>

The non-aqueous electrolyte of a lithium secondary battery of the present invention can be a solution obtained by dissolving an electrolytic salt such as a lithium salt in an organic solvent. Note that the components of the non-aqueous electrolyte and their concentrations, as described in this specification, are at the time when the lithium secondary battery is manufactured. In more detail, for the purpose of describing the non-aqueous electrolyte, the time when the lithium secondary battery is manufactured can be referred to as the time when the non-aqueous electrolyte is injected into the battery case but before applying the initial charge and discharge. As repeating the charge and the discharge, the composition of the non-aqueous electrolyte can be changed, e.g., due to the film formation from the additives contained therein. As one embodiment, the lithium secondary battery of the present invention can be manufactured by using the non-aqueous electrolyte as described below. As another embodiment, the lithium secondary battery of the present invention can include a film resulting from the components and/or additives with the concentrations in the non-aqueous electrolyte, as described below.

The lithium salt used for the non-aqueous electrolyte cannot be particularly limited so long as it can form lithium ions when dissociated in the solvent, and it hardly causes side reactions such as decomposition reaction within the voltage ranges used as a battery. For example, the examples of the lithium salt can include inorganic lithium salts such as LiClO₄, LiPF₆, LiBF₄, LiAsF₆, LiSbF₆; and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n≧2), LiN(RfOSO₂)₂ [where Rf is a fluoroalkyl group]. These compounds can be used alone or in combination.

A suitable lithium salt concentration in the electrolyte solution is, for example, 0.5 to 1.5 mol/l, and in particular, 0.9 to 1.25 mol/l.

The organic solvent used for the non-aqueous electrolyte is not particularly limited so long as the lithium salt can be dissolved therein and side reactions such as decomposition reaction can be hardly caused within the voltage range of the battery used. The Examples thereof can be cyclic carbonates such as ethylene carbonate (EC), propylene carbonate (PC), butylene carbonate (BC); chain carbonates such as dimethyl carbonate (DMC), diethyl carbonate (DEC), methyl ethyl carbonate (MEC); chain esters such as methyl propionate; cyclic esters such as γ-butyrolactone; chain ethers such as dimethoxyethane, diethyl ether, 1,3-dioxolane, diglyme, triglyme, tetraglyme; cyclic ethers such as dioxane, tetrahydrofuran, 2-methyltetrahydrofuran; nitriles such as acetonitrile, propiononitrile, methoxypropiononitril; or sulfites such as ethylene glycol sulfite. These solvents can be used singly or as a combination of two or more.

Also, the non-aqueous electrolyte used for the lithium secondary battery of the present invention can contain vinylene carbonate (VC). The lithium secondary battery containing VC as the non-aqueous electrolyte has a VC origin film formed on the surface of the negative electrode. This film can suppress the deterioration of the non-aqueous electrolyte due to the reaction between the negative electrode and the non-aqueous electrolyte associated with the charge and the discharge of the battery. Therefore, the charge discharge cycle characteristics can be improved. The improvement effects of the charge discharge cycle characteristics by using VC can be remarkable, especially when using carbon materials such as graphite carbon material as a negative electrode active material for the lithium secondary battery.

The content of VC in the non-aqueous electrolyte (*) used in the lithium secondary battery can be 1 mass % or more, and in particular, it is 1.5 mass % or more, when manufacturing the lithium secondary battery. Here, the non-aqueous electrolyte (*) means one which is used in assembling the battery, and hereinafter, the same meaning here applies to the explanation of the content of various components of the non-aqueous electrolyte. When the content of VC in the non-aqueous electrolyte is too large, an excessive amount of gas can be generated, unfavorably causing the swelling of the battery case during the film formation. Therefore, the content of VC in the non-aqueous electrolyte used in the lithium secondary battery can be 10 mass % or lower, and in particular, 5 mass % or lower, when manufacturing the lithium secondary battery.

The non-aqueous electrolyte used in the lithium secondary battery of the present invention can contain a phosphonoacetate compound of the following general formula (2).

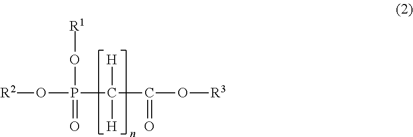

In the general formula (2), each of R¹ to R³ independently represents an alkyl group, alkenyl group or alkynyl group with a carbon number of 1 to 12, with or without a halogen substituent, and n represents an integer of 0 to 6.

The non-aqueous electrolyte used in the lithium secondary battery can be provided with the following features. It can improve the charge discharge cycle characteristics of the battery and the safety regarding the control of e.g., high temperature swelling and overcharging. Namely, the non-aqueous electrolyte can include an additive such as VC, fluoroethylene carbonate, acid anhydride, sulfonate, dinitrile, 1,3-propane sultone, diphenyl disulfide, cyclohexylbenzene, biphenyl, fluorobenzene, t-butylbenzene and succinonitrile, and a derivative thereof. These compounds can be used alone or in combination.

The use of a lithium compound oxide including nickel as a positive electrode active material can enlarge the battery swelling in storage at a high temperature compared with using LiCoO₂ alone as a positive electrode active material. This is considered because active spots can be generated since Ni is unstable at a high temperature, thereby enhancing the reactivity of Ni with the solvent or additive in the non-aqueous electrolyte at a state highly charged. As a result, an excessive amount of gas can be generated between the Ni active spots and the solvent or additive in the non-aqueous electrolyte, resulting in causing a surplus reaction to make the battery swollen. Also, the accumulation of the reaction products at the interface with Ni can raise the battery resistance, or significantly decrease the capacity recovery rate after the storage at a high temperature.

In view of the above, it is conventionally known to provide a lithium secondary battery by using a non-aqueous electrolyte with additives such as 1,3-propane sulton and succinonitrile. These additives can act on the Ni active spots in the battery, suppressing the surplus reaction. As a result, the storage characteristics of the battery can be improved at a high temperature, while suppressing the battery swelling.

However, the charge discharge cycle characteristics might be deteriorated in the lithium secondary battery if using such conventional additives contained as a non-aqueous electrolyte. This is considered as follows. Even if such conventional additives as 1,3-propane sulton and succinonitrile are contained in the non-aqueous electrolyte at a small amount, they can react with other parts than the active spots in the positive electrode active material. The reaction product can be increased and accumulated, causing the decrease of the capacity and the increase of the resistance.

On the other hand, when the non-aqueous electrolyte contains the phosphonoacetate compound represented by the general formula (2), there can be found the following features. Namely, the deterioration of the charge discharge cycle characteristics of the lithium secondary battery can be suppressed. Also, the storage characteristics at a high temperature can be improved, suppressing the battery swelling. The true reasons of these improvements are unknown at this stage, but it is considered that the phosphonoacetate compound can react with the non-aqueous electrolyte, thereby covering the Ni active spots where gases can be formed.

In addition, the film can be formed with the phosphonoacetate compound also at the negative electrode during the initial charge and discharge once after the battery is produced. Since the film by the phosphonoacetate compound is stable in heat, it hardly decomposes during storage of the battery at a high temperature. As a result, it is considered that the increase of the battery resistance can be suppressed. The true reasons to bring such effects are unknown at this stage, but the effects become especially significant in using SiOₓ as a negative electrode active material.

The examples of the phosphonoacetate compound shown by the general formula (2) can be as follows. The Examples of the compounds with n=0 in the above-mentioned general formula (2) are as follows:

The Examples can include: trimethyl phosphonoformate, methyl diethyl phosphonoformate, methyl dipropyl phosphonoformate, methyl dibutyl phosphonoformate, triethyl phosphonoformate, ethyl dimethyl phosphonoformate, ethyl dipropyl phosphonoformate, ethyl dibutyl phosphonoformate, tripropyl phosphonoformate, propyl dimethyl phosphonoformate, propyl diethyl phosphonoformate, propyl dibutyl phosphonoformate, tributyl phosphonoformate, butyl dimethyl phosphonoformate, butyl diethyl phosphonoformate, butyl dipropyl phosphonoformate, methyl bis(2,2,2-trifluoroethyl)phosphonoformate, ethyl bis(2,2,2-trifluoroethyl)phosphonoformate, propyl bis(2,2,2-trifluoroethyl)phosphonoformate, and butyl bis(2,2,2-trifluoroethyl)phosphonoformate).

The Examples of the compounds with n=1 in the above-mentioned general formula (2) are as follows:

The examples can include: trimethyl phosphonoacetate, methyl diethyl phosphonoacetate, methyl dipropyl phosphonoacetate, methyl dibutyl phosphonoacetate, triethyl phosphonoacetate, ethyl diethyl phosphonoacetate, ethyl dipropyl phosphonoacetate, ethyl dibutyl phosphonoacetate, tripropyl phosphonoacetate, propyl dimethyl phosphonoacetate, propyl diethyl phosphonoacetate, propyl dibutyl phosphonoacetate, tributyl phosphonoacetate, butyl dimethyl phosphonoacetate, butyl diethyl phosphonoacetate, butyl dipropyl phosphonoacetate, methyl bis(2,2,2-trifluoroethyl)phosphonoacetate, ethyl bis(2,2,2-trifluoroethyl)phosphonoacetate, propyl bis(2,2,2-trifluoroethyl)phosphonoacetate, butyl bis(2,2,2-trifluoroethyl)phosphonoacetate, allyl dimethyl phosphonoacetate, allyl diethyl phosphonoacetate, and 2-propynyl Dimethyl phosphonoacetate.

The Examples of the compounds with n=2 in the above-mentioned general formula (2) are as follows.

The examples can include: trimethyl-3-phosphonopropionate, methyl diethyl-3-phosphonopropionate, methyl dipropyl-3-phosphonopropionate, methyl dibutyl 3-phosphonopropionate, triethyl-3-phosphonopropionate, ethyl dimethyl-3-phosphonopropionate, ethyl dipropyl-3-phosphonopropionate, ethyl dibutyl 3-phosphonopropionate, tripropyl-3-phosphonopropionate, propyl dimethyl-3-phosphonopropionate, propyl diethyl-3-phosphonopropionate, propyl dibutyl 3-phosphonopropionate, tributyl-3-phosphonopropionate, butyl dimethyl-3-phosphonopropionate, butyl diethyl-3-phosphonopropionate, butyl dipropyl-3-phosphonopropionate, methyl bis(2,2,2-trifluoroethyl)-3-phosphonopropionate, ethyl bis(2,2,2-trifluoroethyl)-3-phosphonopropionate, propyl bis(2,2,2-trifluoroethyl)-3-phosphonopropionate, and butyl bis(2,2,2-trifluoroethyl)-3-phosphonopropionate.
The Examples of the compounds with n=3 in the above-mentioned general formula (2) are as follows.
The examples can include: trimethyl-4-phosphonobutyrate, methyl diethyl-4-phosphonobutyrate, methyl dipropyl-4-phosphonobutyrate, methyl dibutyl 4-phosphonobutyrate, triethyl-4-phosphonobutyrate, ethyl dimethyl-4-phosphonobutyrate, ethyl dipropyl-4-phosphonobutyrate, ethyl dibutyl 4-phosphonobutyrate, tripropyl-4-phosphonobutyrate, propyl dimethyl-4-phosphonobutyrate, propyl diethyl-4-phosphonobutyrate, propyl dibutyl 4-phosphonobutyrate, tributyl-4-phosphonobutyrate, butyl dimethyl-4-phosphonobutyrate, butyl diethyl-4-phosphonobutyrate, and butyl dipropyl-4-phosphonobutyrate.

Among the phosphonoacetates as listed above, triethyl phosphonoacetate (TEPA) can be particularly used.

The content of the phosphonoacetate compound shown by the above-mentioned general formula (2) included in the non-aqueous electrolyte of the lithium secondary battery can be 0.5 mass % or more, and in particular, it can be 1 mass % or more, when manufacturing the lithium secondary battery. As a result, the effects by the phosphonoacetate compound can become excellent. It is noted that when the amount of the phosphonoacetate compound in the non-aqueous electrolyte is too large, a reaction can be caused at other portions than the active spots of the positive electrode active material. In this case, the internal battery resistance can be increased in the same manner as using the conventional additives as described before. Therefore, the content of the phosphonoacetate compound shown by the general formula (2) can be 5 mass % or less, and in particular, 3 mass % or less in the non-aqueous electrolyte of the lithium secondary battery, when manufacturing the lithium secondary battery.

The non-aqueous electrolyte used in the lithium secondary battery of the present invention can include a halogen-substituted cyclic carbonate.

The halogen-substituted cyclic carbonate included in the non-aqueous electrolyte can be decomposed when the battery is placed under excessive high temperature, thereby generating gases. This effect can raise the internal pressure of the battery, thereby acting on early operation of the cleavable groove provided at a specific position of the side part of the battery case. Therefore, it is possible to secure good vent operation of the cleavable groove and high safety of the lithium secondary battery containing the halogen-substituted cyclic carbonate in the non-aqueous electrolyte according to the present invention.

Also, when a lithium secondary battery includes SiOₓ as a negative-electrode material, the SiOₓ particles can be crushed due to the volumetric change by the charge and the discharge. Here, active parts of Si can be exposed by the crush, which can decompose the non-aqueous electrolyte, thereby deteriorating the charge discharge cycle characteristics. However, the halogen-substituted cyclic carbonate can be included in the non-aqueous electrolyte, and can form a film excellently coating new surfaces generated by crushing the SiOₓ particles due to the volumetric change during the charge and the discharge of the battery. As a result, in the lithium secondary battery of the present invention containing the halogen-substituted cyclic carbonate in the non-aqueous electrolyte, a reaction between the negative electrode active material and the non-aqueous electrolyte can be highly suppressed, thereby improving the charge discharge cycle characteristics.

As a halogen-substituted cyclic carbonate, the compound shown by the general type (3) below can be used.

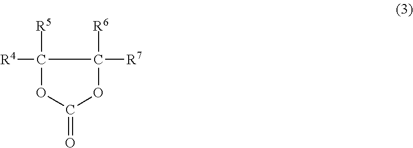

In the general formula (3), R⁴, R⁵, R⁶, and R⁷ represent hydrogen, halogen, or alkyl group with a carbon number of 1 to 10. A part or the whole of the hydrogen of the alkyl group can be substituted with a halogen element. At least one of R⁴, R⁵, R⁶, and R⁷ can be a halogen element. R⁴, R⁵, R⁶, and R⁷ can be the same or different, and the two or more can be identical. When R⁴, R⁵, R⁶, and R⁷ are alkyl group(s), the carbon number can be as small as possible. The halogen element as described here can be fluorine, in particular.

As a cyclic carbonate substituted with a halogen element, 4-fluoro-1,3-dioxolane-2-one (FEC) can be particularly used.

In the non-aqueous electrolyte used in the lithium secondary battery of the present invention, the content of the halogen-substituted cyclic carbonate can be 0.5 mass % or more, and in particular, 1 mass % or more, and more in particular 1.5 mass % or more, when manufacturing the lithium secondary battery. As a result, the vent operation of the cleavable groove can be improved. When the new faces of SiOₓ are exposed, the halogen-substituted cyclic carbonate in the non-aqueous electrolyte can be consumed to form the film covering there. In order to improve the vent operation of the cleavable groove provided on the side part of the battery case, it is necessary not to be completely exhausted in the battery. Namely, some amounts of the halogen-substituted cyclic carbonate should remain. When the non-aqueous electrolyte used in the lithium secondary battery contains the halogen-substituted cyclic carbonate at the amount specified, significant effects can be expected. In this case, even when a negative electrode containing SiOₓ is used, the halogen-substituted cyclic carbonate can remain in the non-aqueous electrolyte, to improve the operation of the cleavable groove provided on the side part of battery case.

It is noted that when the amount of the halogen-substituted cyclic carbonate in the non-aqueous electrolyte is excessive, the swollen amount of the battery can be largely increased even at a high temperature environment of about 85° C., for example. Also, it can decrease the capacity or deteriorate the storage characteristics. In addition, when the negative electrode contains SiOₓ, the activity of SiOₓ can be decreased. Therefore, in the non-aqueous electrolyte used in the lithium secondary battery of the present invention, the content of the halogen-substituted cyclic carbonate can be 5 mass % or less, and in particular, 3 mass % or less.

Also, the non-aqueous electrolyte used in the lithium secondary battery of the present invention can contain the following additives. The examples of the additives can include fluoroethylene carbonate, acid anhydrid, sulfonate, dinitrile, 1,3-propane sulton, diphenyl disulfide, cyclohexylbenzene, biphenyl, fluorobenzene, and t-butylbenzene, and the derivatives thereof. These compounds can be appropriately added depending on the required properties for the battery.

In addition, the non-aqueous electrolyte can include a gelatinizer such as a polymer known in the art, to make it in a gelation state (i.e., a gelation state of the non-aqueous electrolyte). The gelation state of the non-aqueous electrolyte can be used in the lithium secondary battery.

### <Separator>

The separator used in the lithium secondary battery can be the same as conventionally known as a separator of lithium secondary batteries. For example, a polyolefin porous membrane made of polyethylene (PE) and polypropylene (PP), etc. (i.e., microporous membrane) can be used.

When the porous membrane made of polyethylene is used as a separator, it can be provided with the following features. Namely, polyethylene has a melting point of about 130° C., so that when the inside of the battery exceeds 130° C., the separator can be molten and shrunk. As a result, the positive electrode and the negative electrode can cause short-circuit. For the purpose to improve the safety under a high temperature condition, the separator can be a heat resistant resin or a heat resistant inorganic filler laminated thereon.

The separator of the lithium secondary battery of the present invention can be a lamination type separator including a porous layer (I) mainly composed of a thermoplastic resin, and a porous layer (II) mainly composed of s filler with a heat resistance temperature of 150° C. or more. While the details are described later, the separator can be provided with both the shutdown characteristics and the heat resistance (heat resistant shrinkage). This configuration can improve the safety when the lithium secondary battery is exposed to an excessively high temperature, especially when the lithium-containing composite oxide including Ni is used as a positive electrode active material, and applied to a charged voltage exceeding 4.30V.

The phrase “heat resistance temperature of 150° C. or higher” means a temperature of at least 150° C. where no deformation such as softening is observed.

The porous layer (I) of the separator can serve as securing a shutdown function. When the lithium secondary battery reaches a temperature equal to or higher than the melting point of the thermoplastic resin mainly composing the porous layer (I), the thermoplastic resin of the porous layer (I) can be molten. As a result, the pores of the separator are closed, thereby causing shutdown by suppressing the progress of an electrochemical reaction.

The thermoplastic resin mainly composed of the porous layer (I) can be provided with the following features. Namely, it is possible to use a resin with a melting point or a fused temperature of 140° C. or more, especially when measured by using a differential scanning calorimeter (DSC) according to JIS K 7121. For example, PE can be used. Also, an embodiment of the porous layer (I) can be in a sheet form including a base material of a porous membrane or non-woven cloth, i.e., one generally used as a separator for the lithium secondary batteries. The porous layer (I) can be made by applying a dispersion liquid including PE particles on the base material, followed by drying. In the total volume (*) of components of the porous layer (I), the volumetric content of the thermoplastic resin can be 50 volume % or more, and in particular, it can be 70 volume % or more. Here, the total volume (*) above is referred to the entire volume except for the pores. Hereinafter, the same meaning is applied to the volumetric contents of the components of the porous layer (I) and the porous layer (II) of the separator. When the porous layer (I) is formed of the PE porous membrane as described before, the volumetric content of the thermoplastic resin can be 100 volume %.

The porous layer (II) of the laminated separator has a function to prevent a short-circuit caused by direct contact between the positive electrode and the negative electrode when the internal temperature of the lithium secondary battery is increased. This function is secured by using the filler having an upper temperature limit of 150° C. or higher. That is, even when the battery reaches a high temperature to shrink the porous layer (I), short-circuit by a direct contact between the positive and negative electrodes can be prevented by the porous layer (II) since it is unlikely to shrink. Also, the porous layer (II), a heat resistant layer, can serve as a backbone of the separator. Therefore, it can suppress the thermal shrinkage of the porous layer (I), as well as the thermal shrinkage of the separator as a whole.

The filler of the porous layer (II) can be provided with the following features. It has a heat resistance temperature of 150° C. or higher. It is stable in the non-aqueous electrolyte solution contained in the battery. It is so electrochemically stable that it does not cause redox reaction in the operational voltage range of the battery. It can be either of organic or inorganic particles, but in view of the dispersibility, it can be of fine particles. In particular, it can be of inorganic oxide particles. In detail, it can be alumina, silica, or boehmite. Alumina, silica, and boehmite have a high level of oxidation resistance. Their particle sizes and shapes can be adjusted into a numerical value as desired. As a result, precise control of the porosity of the porous layer (II) can be available. The filler, having a heat resistance temperature of 150° C. or higher, can be inorganic filler which can be used alone or in combination.

The shape of the filler having a heat resistance temperature of 150° C. or higher of the porous layer (II) is not particularly limited. The shape thereof can be a substantially spherical shape (including a perfectly spherical shape), a substantially spheroidal shape (including a spheroidal shape), and a plate shape.

When the porous layer (II) includes the filler having a heat resistance temperature of 150° C. or higher in which its average particle diameter is too small, the ion permeability can be impaired. Therefore, the average particle diameter can be 0.3 μm or more, and in particular, 0.5 μm or more. On the other hand, when the porous layer (II) includes the filler having a heat resistance temperature of 150° C. or higher in which the average particle diameter is too large, the electrical characteristics can be deteriorated. Therefore, the average particle diameter thereof can be 5 μm or less, and in particular, 2 μm or less.

The filler is contained as a primary component in the porous layer (II). Therefore, in the total volume of the components of the porous layer (II), the filler having the heat resistance temperature of 150° C. or higher can be included at an amount of 50 volume % or more, and in particular, 70 volume % or more, and yet in particular, 80 volume % or more, and further in particular, 90 volume % or more. When the filler is contained in the porous layer (II) at a large amount as specified above, the thermal shrinkage of the separator can be suppressed as a whole even when the lithium secondary battery is raised at a high temperature. As a result, a short-circuit due to direct contact between the positive electrode and the negative electrode can be avoided.

It is noted that the porous layer (II) can include an organic binder as described later. In view of the above, the filler having the heat resistance temperature of 150° C. or higher can be included at an amount of 99.5 volume % or less in the total volume of the components in the porous layer (II).

The porous layer (II) can contain an organic binder. As a result, a resin which doesn't melt at a temperature of 150° C. or less can be adhered to the filler having the heat resistance temperature of 150° C. or more. Moreover, the porous layer (II) can be integrated with the porous layer (I). The examples of the organic binder include ethylene-vinylacetate copolymers (EVAs, those having a structural unit derived from vinyl acetate of 20 to 35 mol %), ethylene-acrylic acid copolymers such as ethylene-ethyl acrylate copolymers, fluorine-based rubber, styrene-butadiene rubber (SBR), carboxymethylcellulose (CMC), hydroxyethylcellulose (HEC), polyvinyl alcohol (PVA), polyvinyl butyral (PVB), polyvinyl pyrrolidone (PVP), crosslinked acrylic resins, polyurethane, epoxy resins, and the like. In particular, heat resistant binders having a heat resistance temperature of 150° C. or higher can be used. The organic binders presented above as examples can be used singly or used in a combination of two or more.

Among the organic binders as listed above, a highly flexible organic binder such as EVAs, ethylene-acrylic acid copolymers, fluorine-based rubber, SBR, and like binders can be used. Specific examples of such highly flexible organic binders can include EVAs “EVAFLEX series” of Du Pont-Mitsui Polychemicals Co., Ltd., EVAs of Nippon Unicar Co., Ltd., ethylene-acrylic acid copolymers “EVAFLEX EEA series” of Du Pont-Mitsui Polychemicals Co., Ltd., EEAs of Nippon Unicar Co., Ltd., fluororubber “Daiel Latex series” of Daikin Industries, Ltd., SBR “TRD-2001” of JSR Corporation, SBR “BM-400B” of Zeon Corporation, and the like.

When the organic binder is used in the porous layer (II), the organic binder can be made into a form of solution or emulsion by dissolved or dispersed in the solvent of the composition for preparing the porous layer (II), as described later.

The separator can be produced as follows: For example, a composition is prepared to form a porous layer (II) containing a filler having the heat resistance temperature of 150° C. or more (e.g., a liquid composition in a form of slurry). The composition, then, is applied to a surface of the porous layer (I), a porous membrane in a sheet form, and dried at a specific temperature to obtain a separator.

The composition for forming the porous layer (II) can contain an filler having a heat resistance temperature of 150° C. or more, and an organic binder if necessary, which are dispersed in a solvent (e.g., a dispersion medium). The same meaning of the solvent applies hereinafter. It is noted that the organic binder can be dissolved in a solvent. The solvent used in the composition for forming the porous layer (II) can uniformly disperse the filler having a heat resistance temperature of 150° C. or more, and the organic binder. For example, the solvent can be aromatic hydrocarbons such as toluene; furans such as tetrahydrofuran; ketones such as methyl ethyl ketone and methyl isobutyl ketone; and other organic solvents. The solvent can also include alcohols (e.g., ethylene glycol and propylene glycol), or various propylene oxide-based glycol ethers such as monomethyl acetate in order to control the surface tension. When the organic binder is aqueous, water can be used to form an emulsion. In this case, the addition of alcohols (e.g., methyl alcohol, ethyl alcohol, isopropyl alcohol, ethylene glycol) can control the surface tension, as well.

The composition for forming the porous layer (II) can include a solid content of 10 to 80 mass %, including the filler having the heat resistance temperature of 150° C. or more higher, the organic binder.

Regarding the separator, each of the porous layer (I) and the porous layer (II) does not have to be single layer; multiple layers of each can be provided to form the separator. For example, the separator can be provided with a configuration in which the porous layer (I) is disposed on both sides of the porous layer (II), or in which the porous layer (II) is disposed on both sides of the porous layer (I). It is, however, noted that the increase of the number of the layers can also increase the thickness of the separator, thereby increasing the internal battery resistance as well as decreasing the energy density. Therefore, it can be avoided to provide excess number of the layers. Thus, the total number of the layers including the porous layer (I) and the porous layer (II) can be 5 or less in the separator.

The thickness of the separator (*) can be 10 to 30 μm. Here, the separator (*) is referred to a porous membrane of polyolefin, or a laminated separator, as explained before.

In the laminated separator, the thickness (*) of the porous layer (II) can be 3 μm or more in order to effectively obtain the effects by the porous layer (II). Here, the thickness (*) is referred to the total thickness if multiple layers are provided as the porous layer (II). The same meaning of the thickness (*) applies hereinafter. It is noted that when the porous layers (B) is too thick, the energy density of the battery can be decreased. Thus, the thickness of the porous layer (II) can be 8 μm or less.

In addition, the thickness(*) of the porous layer (I) in the laminated separator can be 6 μm or more, and in particular, 10 μm or more, in order to effectively obtain the effects (e.g., the shutdown effect) resulting from the porous layer (I). Here, the thickness(*) above is referred to the total thickness if the separator has multiple layers of the porous layers (I). The same meaning of the thickness(*) applies hereinafter. It is, however, noted that when the porous layers (I) is too thick, the energy density of the battery can be decreased. In addition, the force to cause the thermal shrinkage at the porous layers (I) can be enhanced, impairing the action to suppress the thermal shrinkage as a whole of the separator. Therefore, the thickness of the porous layer (I) can be 25 μm or less, and in particular, 20 μm or less, and yet in particular, 14 μm or less.

The total porosity of the separator in a dry state can be 30% or more, in order to secure the retaining amount of the electrolyte solution and good ion permeability. On the other hand, in view of securing the separator strength and avoiding the internal short-circuit, the porosity of the separator in a dry state can be 70% or less. Here, the porosity P (%) of the separator can be calculated from the thickness, the mass per area, and the density of the components of the separator. The sum of each component i can be calculated by using formula (4) below.

P={1−(m/t)/(Σaᵢ·ρᵢ)}×100 (4)

In formula (4) above, aᵢ is the proportion of component i when the total mass is 1; ρᵢ is the density (g/cm³) of component i; m is the mass per unit area (g/cm²) of the separator; and t is the thickness (cm) of the separator.

In the laminated separator, the porosity P(%) of the porous layer (I) can be calculated by using formula (4) as shown above. Here, m is the mass per unit area (g/cm²) of the porous layer (I); t is the thickness (cm) of the porous layer (I); and aᵢ is the proportion of component i when the total mass of the porous layer (I) is 1. The porosity of the porous layer (I) as calculated by the method above can be 30 to 70%.

Moreover, in the laminated separator, the porosity P (%) of the porous layer (II) can be calculated by using formula (4) as shown above. Here, m is the mass per unit area (g/cm²) of the porous layer (II); t is the thickness (cm) of the porous layer (II); and aᵢ is the proportion of component i when the total mass of the porous layer (II) is 1. The porosity of the porous layer (II) calculated by the method can be 20 to 60%.

The separator can have a high level of mechanical strength. For example, it can have a piercing resistance of 3N or greater. However, repetitive charge and discharge cycles bring about expansion and contraction of the negative electrode as a whole, thereby mechanically damaging the separator that faces the negative electrode. With a separator having a piercing resistance of 3N or greater, good mechanical strength can be secured, and it is thus possible to alleviate the mechanical damage the separator receives. When the separator has the configuration as specified above, it can be provided with the piercing resistance as defined above.

The piercing resistance can be measured by the following method. A separator is fixed on a plate having a 2-inch diameter hole such that no wrinkles or deflection are formed. A hemispherical metal pin having a tip diameter of 1.0 mm is lowered toward the measurement sample at a rate of 120 mm/min, and the force when piercing the separator to make a hole is measured five times. Among the five results of the measurements, the largest result and the lowest result are removed. The remaining results of the three measurements are averaged to obtain a piecing resistance of the separator.

### <Electrode Body>

The positive electrode, the negative electrode and the separator described above can be used as a lithium secondary battery of the present invention in the form of a laminated electrode body. Here, the positive electrode and the negative electrode are stacked to each other with the intervention of the separator therebetween, or in the form of a rolled electrode body obtained by spirally winding the laminated electrode body.

When using such a laminated separator including the porous layer (I) and the porous layer (II) in the form of the laminated electrode body or the rolled electrode body, the porous layer (II) of the separator can face a surface of the positive electrode. When the surface of the positive electrode faces the porous layer (II) that is mainly composed of the filler having a heat resistance temperature of 150° C. or more and excellent in oxidation resistance, the oxidation of the separator by the positive electrode can be suppressed. As a result, the high-temperature storage characteristics and the charge discharge cycle characteristics of the battery can be enhanced. Also, when using a non-aqueous electrolyte including additives such as VC and cyclohexylbenzene, a film formation at the side of the positive electrode can close the fine pores of the separator, thereby impairing the battery characteristics. However, the positive electrode facing the porous layer (II), i.e., a layer that is relatively porous, can avoid the fine pores from closed.

On the other hand, when one surface of the separator is of the porous layer (I), the porous layer (I) can face the negative electrode. As a result, in e.g., a shutdown situation, a molten state of the thermoplastic resin from the porous layer (I) can be avoided from absorbed by the electrode mixture layer, thereby utilizing it to close or block the pores of the separator.

### <Battery Case>

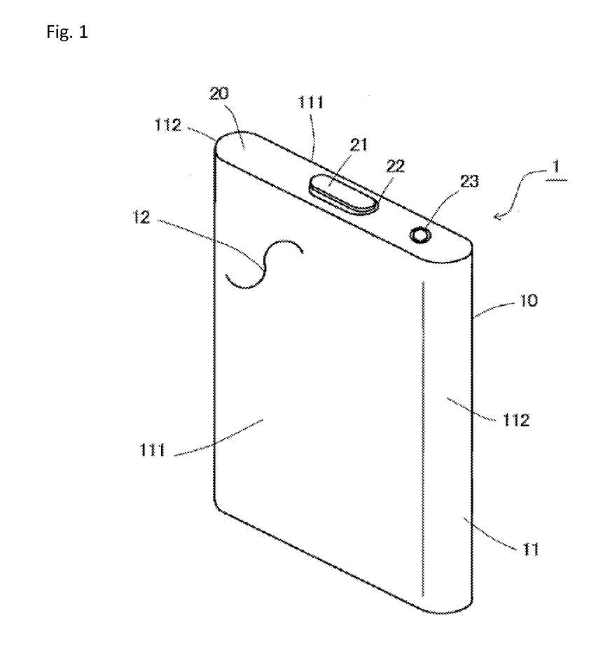

FIG. 1 illustrates a perspective view of an example of the lithium secondary battery of the present invention. The lithium secondary battery 1 in FIG. 1 has a battery case 10 having a columnar shaped. The battery case 10 is hollow. In its inside, the positive electrode, the negative electrode, the separator, and the non-aqueous electrolyte are housed.

The battery case 10 is composed of an exterior can 11 and a lid 20. The exterior can 11 has a tubular shape with a bottom (rectangular bottom). At the edge of the opening, a lid 20 is placed and welded to be integrated to each other. For example, the exterior can 11 and the lid 20 can be made of aluminum base alloy.

A terminal 21 is made of a material such as stainless steel, which is protruded from the lid 20. An insulation packing 22 is made of a material such as PP, which is interposed between the terminal 21 and the lid 20. For example, the terminal 21 is connected to the negative electrode inside the battery case 10. In that case, the terminal 21 can function as a negative electrode terminal, and the exterior can 11 and the lid 20 can function as a positive electrode terminal. It is noted that depending on the material of battery case 10, the terminal 21 can connect to the positive electrode inside the battery case 10, functioning as a positive electrode terminal, and the exterior can 11 and the lid 20 can function as a negative electrode terminal. Also, the lid 20 is provided with a non-aqueous electrolyte injection port, which can be sealed by using a sealing material 23, after the non-aqueous electrolyte is injected in battery case 10.

The side parts of the battery case 10, that is, the side parts of the exterior can 11 are opposed to each other. In the side view, two side surfaces 111, 111 are provided, which are wider than the other surfaces 112, 112. Also, at least one of the wide surfaces 111, 111 (i.e., the wide surface 111 at the front side in FIG. 1) has a cleavable groove 12, which can be cleaved when the pressure inside the battery case 10 exceeds a threshold.

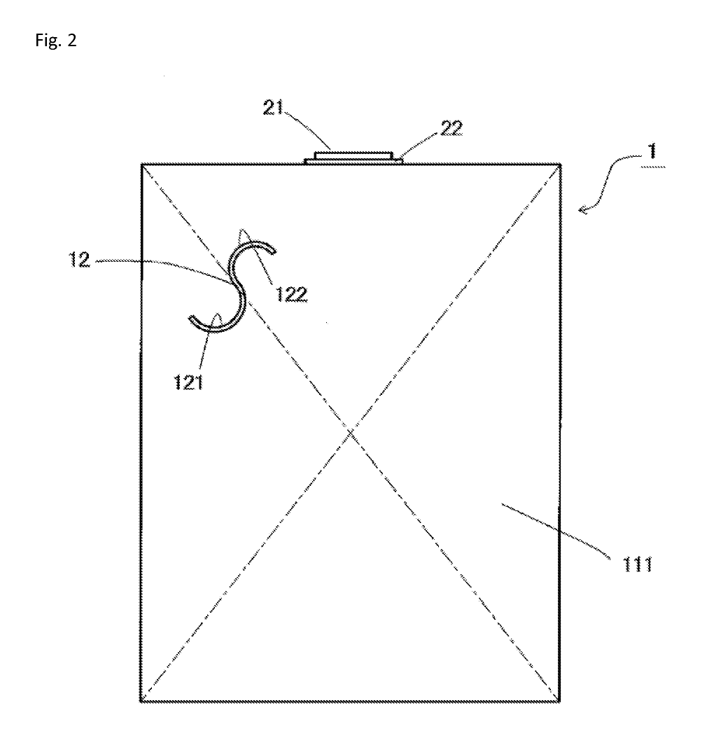

FIG. 2 shows a side view when the battery case 10 of the lithium secondary battery shown in FIG. 1 is seen from the wide surface 111. As shown in FIG. 2, the cleavable groove 12 is provided at a portion to intersect with the diagonal of the wide surface 111 (i.e., the long and short dashed line in the figure) in the side view. The diagonal is drawn to connect the corners of the wide surface 111 when observing the side surface of battery case 10 to perceive a two dimension shape.

As shown in FIGS. 1 and 2, the battery case of to the lithium secondary battery of the present invention has two wide surfaces opposed to each other on its side parts. The cleavable groove on the side part of the battery case can be cleaved, when the pressure inside the battery case exceeds the threshold. This cleavable groove is provided at a portion to intersect with the diagonal in the side view of the wide surface.

In a conventional lithium secondary battery, a cleavable vent is provided on the lid. When the internal pressure is raised when the battery is placed at an excessive high temperature, the cleavable vent can be cleaved to release the internal gases, to lower the pressure. As a result, the safety can be secured by preventing the battery explosion. However, especially when a lithium secondary battery is designed into a high capacity by using a high capacity active material and charged in a condition of a voltage exceeding 4.30V and then placed under an excessive high temperature, the internal battery pressure can be raised rapidly. In this case, it is concerned that the battery might be exploded before the cleavable vent is operated.

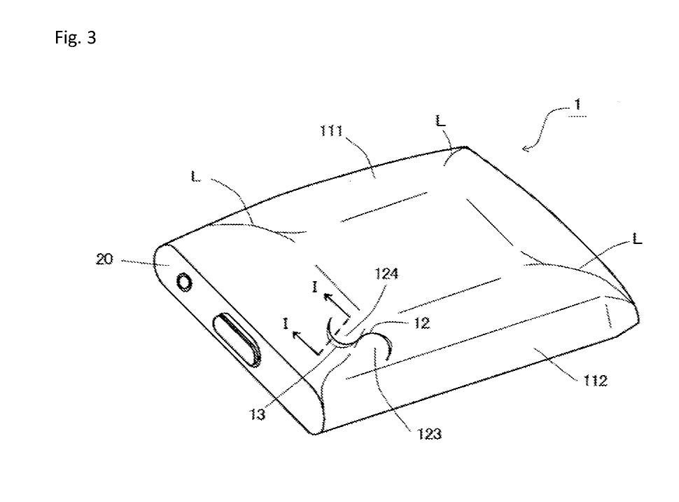

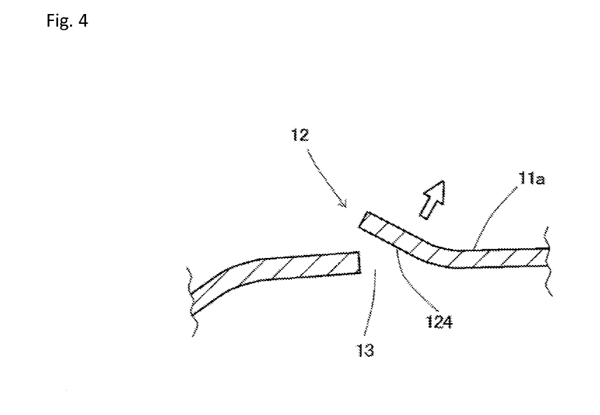

FIG. 3 shows a perspective view illustrating the appearance of the lithium secondary battery of FIG. 1 when the internal pressure inside the battery is raised. FIG. 4 shows a cross-sectional view at the line I-I of FIG. 1. As shown in FIGS. 3 and 4, when the internal pressure of the lithium secondary battery 1 is raised to cause swelling, the cleavable groove 12 is cleaved. As a result, an opening 13 is formed at the cleaved portion to release the internal gases from the opening 13.

As shown in FIG. 3, when the battery case swells as the internal pressure of the lithium secondary battery is rapidly raised, ridge lines (i.e., the line is L in the drawing) are generated in the vicinity of the portion corresponds to the diagonal in the side view of the wide surface of the battery case. Along the ridge lines L, an especially large stress can be applied to the sidewall of the side part. In view of the above, the cleavable groove of the present invention is provided in the lithium secondary battery at a portion to intersect with the diagonal where such an especially large stress is applied when the swelling occurs as the internal pressure is rapidly raised. As a result, the threshold to operate the cleavable groove can be lowered when the internal pressure of the battery is rapidly raised. Therefore, its vent operation speed can be enhanced, thereby improving the safety.

It is noted that the lithium-containing composite oxide shown by the general composition formula (1) used as a positive electrode active material is highly reactive with the non-aqueous electrolyte. Therefore, especially when a charged battery is placed under excessive high temperature, the non-aqueous electrolyte can be decomposed to generate gases. In the second embodiment of the lithium secondary battery of the present invention, the positive electrode uses the lithium-containing composite oxide shown by the general composition formula (1) in combination with Ni at the molar ratio in all the positive electrode active materials as specified before. As a result, when the battery is placed under excessive high temperature, the cleavable groove can be effectively cleaved with an enhanced operational speed of the cleavable groove. Therefore, a high capacity can be accomplished while securing a high safety.

Also, as mentioned before, when the lithium secondary battery uses the non-aqueous electrolyte containing the halogen-substituted cyclic carbonate in the battery which is placed under an excessive high temperature, gases are generated from the halogen-substituted cyclic carbonate in the non-aqueous electrolyte. In this case, the generated gases can rapidly raise the internal battery pressure into the threshold to operate the cleavable groove, and therefore, the operational speed of the cleavable groove can be improved.

In addition, as mentioned before, when the lithium secondary battery has the negative electrode containing SiOₓ which is placed under an excessive high temperature, the expansion of the negative electrode containing SiOₓ can enhance the operational speed of the cleavable groove.

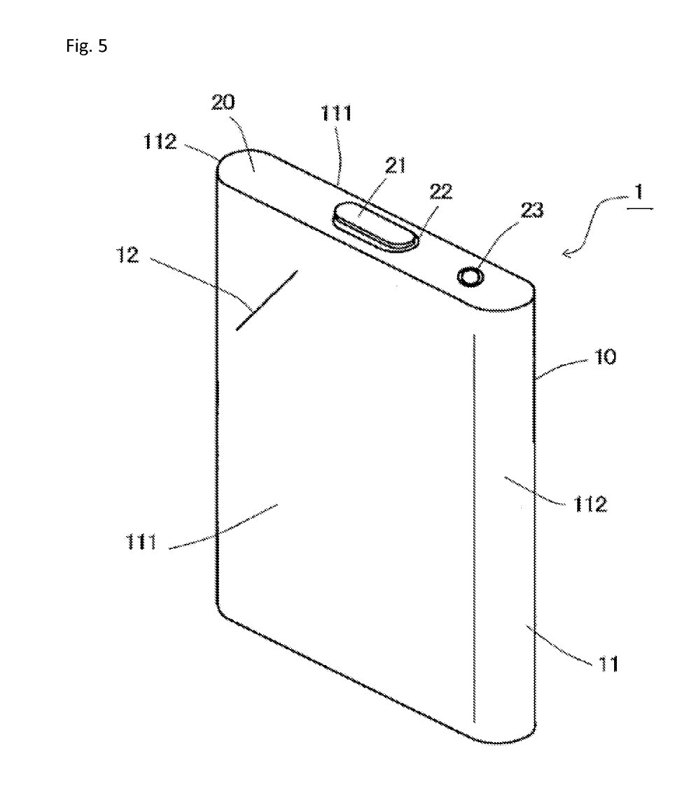

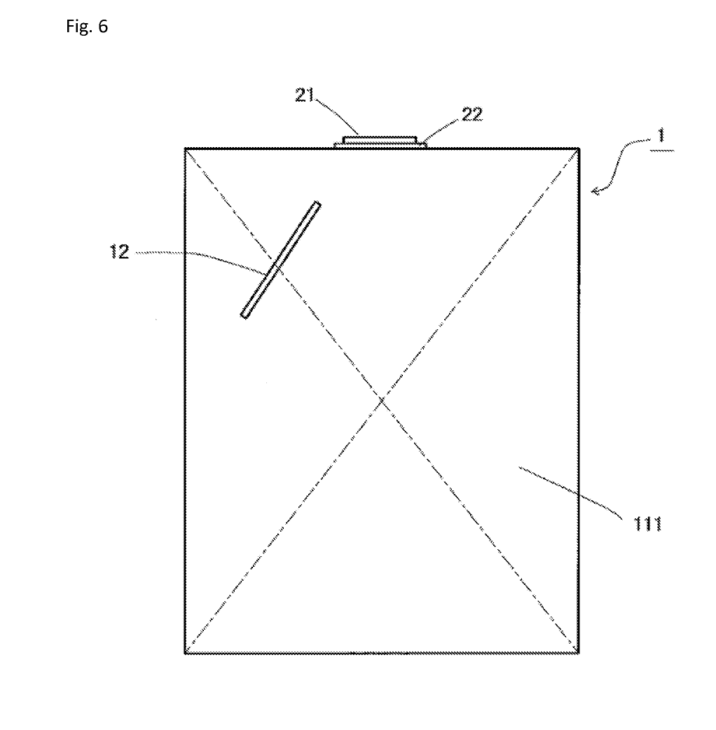

FIG. 5 illustrates a perspective view of another example of the lithium secondary battery of the present invention. FIG. 6 illustrates a side view of the lithium secondary battery of FIG. 5. The lithium secondary battery shown in FIGS. 5 and 6 is an embodiment in which a straight line of the cleavable groove is formed on the side part of the battery case 10.

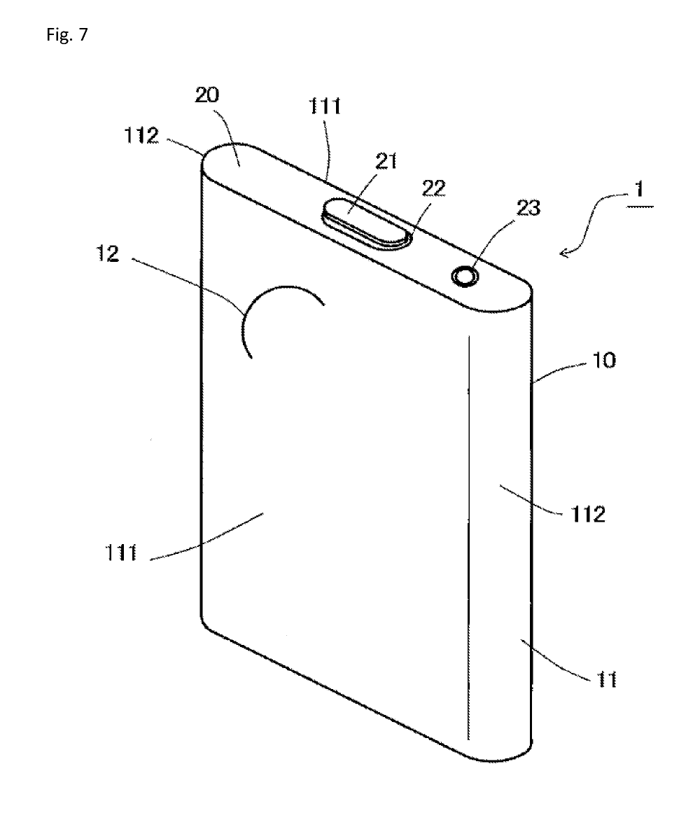

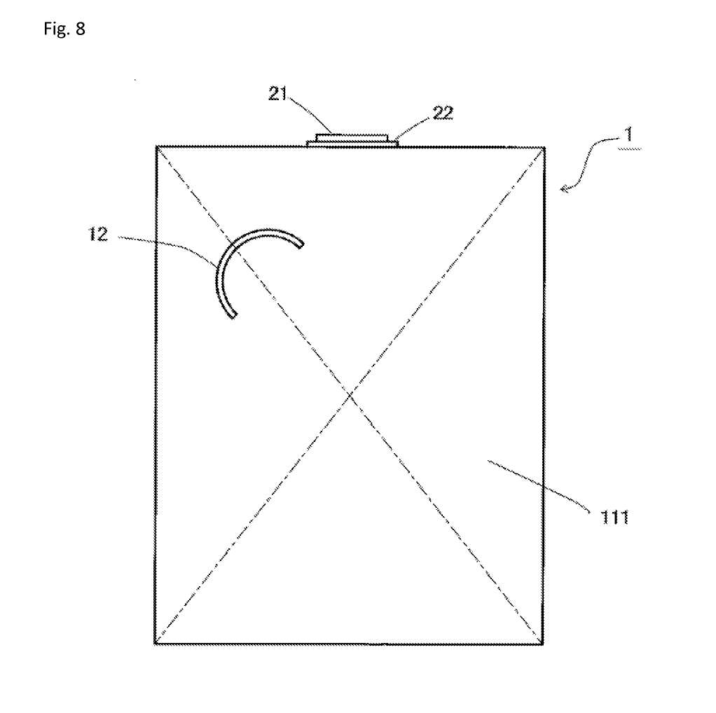

FIG. 7 illustrates a perspective view of yet another example of the lithium secondary battery of the present invention. FIG. 8 illustrates a side view of the lithium secondary battery of FIG. 7. The lithium secondary battery shown in FIGS. 7 and 8 is an embodiment in which a curved line of the cleavable groove is formed on the side part of the battery case 10.

In this way, the lithium secondary battery of the present invention has the cleavable groove provided on the side part of the battery case, but the shape thereof is not especially limited. For example, the straight line as shown in FIGS. 5 and 6 can be formed. Alternatively, the curve line as shown in FIGS. 7 and 8 can be formed. Yet alternatively, as shown in FIGS. 1 to 3, the cleavable groove is made of a cleavable line having a shape, which, in the side view, includes an inward curved part that projects toward the inside of the side part of the battery case 10, and an outward curved part that projects toward the outside of the side part of the battery case 10. The cleavable groove 12 shown in FIGS. 1 to 3 can be cleaved along the cleavable line, when the pressure inside the battery case 10 exceeds the threshold.

Among the examples above, the cleavable groove can be particularly in a curved shape as shown in FIGS. 1 to 3 or FIGS. 7 and 8. When the cleavable groove formed in a curved shape, the total length of the groove within a narrow area can be longer than forming such a groove in a straight line. As a result, the area of the opening region when cleaved can be increased. Therefore, the gases generated inside the battery can be released more efficiently.

In addition, as shown in FIGS. 1 to 3, the lithium secondary battery in its side view can be provided with a cleavable groove made of a cleavable line having a shape which includes an inward curved part that projects toward the inside of the side part of the battery case, and an outward curved part that projects toward the outside of the side part of the battery case. Such a cleavable line to form the cleavable groove has the inward curved part and the outward curved part, so that it can avoid the cleavable groove from cleaved when the battery case receives an impact. Namely, when the cleavable groove is a straight line and receives an impact from the outside in the direction of the straight line, the cleavable groove can be suddenly cleaved. However, with the embodiment described above, the cleavage can be more excellently controlled at an external impact from a specific direction. Therefore, such an embodiment can effectively avoid the cleavable groove from cleaved when receiving an external impact to leak out the non-aqueous electrolyte of the battery.

Also, when the cleavable line is provided with the inward curved part and the outward curved part as specified above, the cleavable groove can be cleaved along the cleavable line. In this case, each of the projection formed by the inward curved part and the projection formed by the outward curved part can be toward the outside of the battery. As a result, the opening formed by the cleavage of the cleavable groove can be enlarged. Therefore, the gases generated inside the battery can be released out more efficiently. Moreover, in this configuration, the projection formed by the cleavage of the cleavable groove can be located in the direction toward the outside of the battery. This configuration can effectively avoid short-circuit between the inside of the battery and the battery case at the cleaved part.

When the cleavable groove is composed of the cleavable line having the inward curved part and the outward curved part, alternate location of the inward curved part and the outward curved part can be provided, as shown in FIGS. 1 to 3. This cleavable line can be provided on the wide surface of the side part of the battery case.

When the inward curved part and the outward curved part are alternately provided and cleaved at the cleavable groove, both the projection at the inward curved part and the projection at the outward curved part can be protruded toward the external direction of the battery. As a result, the opening formed by the cleavage of the cleavable groove can be enlarged. Therefore, the gases generated inside the battery can be released efficiently. Moreover, the alternate provision of the inward curved part and the outward curved part can make such protrusions that can be formed at each curved part and assuredly protruded in the external direction of the battery. Therefore, this configuration can effectively avoid the protrusions from entering the battery inside to cause short-circuit.

When the inward curved part and the outward curved part are alternately located to form the cleavable line of the cleavable groove, the cleavable line can be composed of a single pair of the inward curved part and the outward curved part, which is provided on the side part of the battery case. Such a configuration can easily cleave the cleavable groove when the battery case is swollen. Also, when the cleavable groove is cleaved, a large opening can be easily formed.

Also, when the cleavable groove is made of a cleavable line having the inward curved part and the outward curved part, a connection part of the inward curved part and the outward curved part can be located on the diagonal of the wide surface of the side part of the battery case, in the side view as shown in FIG. 2.

As described before, the portion corresponding to the diagonal in the side view of the wide surface of the side part of the battery case can become a ridge line when the battery case is swollen. Therefore, as shown in FIG. 3, when the connection part of the inward curved part and the outward curved part is provided on the diagonal, the cleaving can be promoted from the connection part toward the inward curved part and the outward curved part when battery case 10 is swollen. As a result, the whole of cleavable groove 12 can be cleaved. Then, when the cleavable groove 12 is cleaved, tongue parts 123, 124 can be formed corresponding to the shape of the inward curved part and the outward curved part (i.e., the semicircle shape of the tongue part in the figure).

In this case, as shown in FIG. 4, there can be formed a lifted part of the tongue part 123, 124 compared with the other parts of the sidewall of the battery case (i.e., the sidewall 11a of the exterior can) when cleaving the cleavable groove 12. Therefore, the opening 13 can be formed. Namely, a cut can be formed on the sidewall (i.e., the sidewall 11a of the exterior can) of the battery case when the cleavable groove 12 is cleaved. A part near the corner on the ridge line L is pulled out in the direction of the corner of the battery case. The tongue parts 123, 124 are lifted upper than the other parts of the sidewall 11a (see the arrow in FIG. 4). As a result, the opening formed by the cleavage of the cleavable groove can be enlarged. Therefore, the gases generated inside the battery can be released out more efficiently.

When the cleavable groove has the shape with the cleavable line having the inward curved part that projects toward the inside of the side part of the battery case and the outward curved part that projects toward the outside of the side part of the battery case, the details can be illustrated in FIG. 2. Namely, the inward curved part 121 and the outward curved part 122 can be almost the same in size. When the cleavable groove is cleaved as raising the internal battery pressure, the tongue parts 123, 124 can be formed with a shape of semicircle as shown in FIG. 3.

Also, the cleavable groove can be formed such that the depth of a part on the diagonal in the side view of the wide surface of the battery case is deeper than the other parts. As described before, the part near the diagonal can form a ridge line when the battery case is swollen. When the depth of the cleavable groove is adjusted as described here, the part located on the ridge line of the cleavable groove can be easily cleaved. In this case, the depth of the cleavable groove can be continuously inclined, or can be provided stepwise from the deep part to the shallow part.

In addition, when the cleavable groove has a shape of a cleavable line having an inward curved part that projects toward the inside of the side part of the battery case and an outward curved part that projects toward the outside of the side part of the battery case, there can be the following configuration. Namely, the cleavable groove can be made of two or more independent groove parts, which are aligned to form the cleavable line. In this case, the battery can be effectively protected from having the cleavable groove cleaved when the battery receives impacts as it is fallen. In addition, the battery case can be swollen to cleave the several groove parts, such that they are connected. Therefore, it becomes possible to easily cleave it along the cleavable line.

The cleavable groove can be formed during the process when the exterior can of the battery case is formed through a press working. The press working can make the part near the cleavable groove hardened. As a result, the strength in the vicinity of the cleavable groove can be enhanced. Therefore, even when an impact is applied to the lithium secondary battery as it fallen, it can be protected from having the cleavable groove cleaved.

The shape of the battery case (i.e., shape of the exterior can) can be provided with a corner part between the wide surface and the other surface (e.g., a shape such as a hexahedron). Also, there can be a curved shape (*) formed between the wide surface and the other surface, as shown in FIGS. 1, 5 and 7. Here, the curved shape (*) is referred to as a shape having a curve such as an arc shape, which can be formed on the other surface such as the lid provided on the upper surface part, and the bottom part.

It is noted that the present invention is advantageous when the battery case has a curved shape between the wide surface of the side part and the other surface, and especially when the other surface is curved. In this case, even when the battery case is swollen, the pulling force generated at a part between the wide surface and the other surface can be smaller than a hexahedron battery case. Accordingly, the force applied to the cleavable groove can be reduced. However, the lithium secondary battery of the present invention has the cleavable groove provided on the part where an especially large stress is applied when the battery case is swollen (i.e., a part to intersect with the diagonal in the side view of the wide surface of the side part). Therefore, the opened space when cleaved can be enlarged. As a result, the gases generated in the battery can be efficiently released.

The lithium secondary battery of the present invention can be used in applications same as those lithium secondary batteries which have been conventionally known in the art.

### EXAMPLES

Hereinafter, the present invention is described in detail with reference to the examples. However, the examples here should not be construed to limit the scope of the present invention.

### <Synthesis of Lithium-Containing Composite Oxide a Including Ni>

Adding sodium hydroxide, an ammonia solution with an adjusted pH of about 12 was prepared, which was put into a reaction container. While strongly stirring, an aqueous mixture of nickel sulfate, cobalt sulfate and the manganese sulfate, each including at 2.4 mol/dm³, 0.8 mol/dm³ and 0.8 mol/dm³ respectively, and an ammonia solution having a concentration of 25 mass % were dropped therein at a rate of 23 cm³/minute and at a rate of 6.6 cm³/minute, respectively, by using a metering pump. Therefore, a co-precipitation compound of Ni, Co, and Mn (i.e., co-precipitation compound in a spheroidal shape) was synthesized. In the process, the temperature of the reaction liquid was kept at 50° C. Also, an aqueous solution of sodium hydroxide at a concentration of 6.4 mol/dm³ was simultaneously dropped to keep the pH of the reaction liquid at about 12. In addition, nitrogen gas was supplied with bubbling at a flow rate of 1 dm³/minute.

The co-precipitation compound was washed with water, filtered and dried, to obtain a hydroxide containing Ni, Co, and Mn at a molar ratio of 6:2:2. The hydroxide (0.196 mols) and LiOH.H₂O (0.204 mols) were dispersed in ethanol to obtain a slurry. Then, the mixing was continued for 40 minutes in a planetary ball mill, and dried at room temperature, to obtain a mixture. Next, the mixture was put in a crucible made of alumina, and heated up to 600° C. with dry air flowing at a rate of 2 dm³/minute. The temperature was kept for two hours to maintain the preliminary heating. Finally, the temperature was raised to 900° C. to fire for 12 hours to obtain a lithium-containing composite oxide A (Li-containing composite oxide).

The lithium-containing composite oxide A as obtained was washed with water, and then, it was applied to a heat treatment at 850° C. for 12 hours in the atmosphere (i.e., oxygen concentration of about 20 vol %). Then, it was pounded with a mortar to obtain fine particles. The lithium-containing composite oxide A as pounded was stored in a desiccator.

The lithium-containing composite oxide A was applied to a chemical composition analysis by means of the ICP method. First, the lithium-containing composite oxide A (0.2 g) was collected and put into a 100 mL vessel. Therein, pure water (5 mL), aqua regia (2 mL) and pure water (10 mL) were added in this order, for heat dissolution. After cooling, the mixture was diluted by 25 times, and then, the composition was analyzed by the ICP (made by the JARRELASH company “ICP-757”) (calibration curve method). The composition of the lithium-containing composite oxide A was obtained from the results, which showed that it had a composition of Li_{1.02}Ni_{0.6}Co_{0.2}Mn_{0.2}O₂.

### <Synthesis of Lithium-Containing Composite Oxide B Including Ni>

Adding sodium hydroxide, an ammonia solution with an adjusted pH of about 12 was prepared, which was put into a reaction container. While strongly stirring, a mixture of nickel sulfate, the manganese sulfate and cobalt sulfate, each including at 3.76 mol/dm³, 0.21 mol/dm³, 0.21 mol/dm³, respectively, and an ammonia solution having a concentration of 25 mass % were dropped therein at a rate of 23 cm³/minute and at a rate of 6.6 cm³/minute, respectively, by using a metering pump. Therefore, a co-precipitation compound of Ni, Mn and Co (i.e., co-precipitation compound in a spheroidal shape) was synthesized. In the process, the temperature of the reaction liquid was kept at 50° C. Also, an aqueous solution of sodium hydroxide at a concentration of 6.4 mol/dm³ was simultaneously dropped to keep the pH of the reaction liquid at about 12. In addition, nitrogen gas was supplied with bubbling at a flow rate of 1 dm³/minute in order to react them under an inert atmosphere.

The co-precipitation compound was washed with water, filtered and dried, to obtain a hydroxide containing Ni, Mn and Co at a molar ratio of 90:5:5. The hydroxide (0.196 mols), LiOH.H₂O (0.204 mols) and TiO₂ (0.001 mol) were dispersed in ethanol to obtain a slurry. Then, the mixing was continued for 40 minutes in a planetary ball mill, and dried at room temperature, to obtain a mixture. Next, the mixture was put in a crucible made of alumina, and heated up to 600° C. with dry air flowing at a rate of 2 dm³/minute. The temperature was kept for two hours to maintain the preliminary heating. Finally, the temperature was raised to 800° C. to fire for 12 hours to obtain a lithium-containing composite oxide B. The lithium-containing composite oxide B as obtained was grounded into fine particles with a mortar, and then, stored in a desiccator.

The lithium-containing composite oxide B obtained was applied to a chemical composition analysis through a calibration curve method under the ICP method as mentioned before. The composition of the lithium-containing composite oxide B was obtained from the results, which showed that it had a composition of Li_{1.02}Ni_{0.895}Co_{0.05}Mn_{0.05}Ti_{0.005}O₂.

### <Synthesis of Lithium-Containing Composite Oxide C Including Ni>

By adjusting the concentrations of the raw material compounds in the mixture solutions used for synthesizing the co-precipitation compound, a hydroxide containing Ni, Co, and Mn at a molar ratio of 1:1:1 was synthesized. Other than that, the same processes as preparing the lithium-containing composite oxide A were carried out to synthesize a lithium-containing composite oxide C. The lithium-containing composite oxide obtained was applied to a chemical composition analysis through a calibration curve method under the ICP method as mentioned before. The composition of the lithium-containing composite oxide C was obtained from the results, which showed that it had a composition of Li_{1.02}Ni_{0.3}Co_{0.3}Mn_{0.3}O₂.

### Example 1

### <Preparation of Positive Electrode>

The lithium-containing composite oxide A and LiCoO₂ as another lithium-containing composite oxide were collected to satisfy the mass ratio shown in Table 1. They were mixed for 30 minutes with a HENSCHEL mixer. 100 parts by mass of the mixture (positive electrode active material) as obtained; 20 parts by mass of an NMP solution of PVDF and P(TFE-VDF); 1.04 parts by mass of carbon fiber serving as a conductive assistant having an average fiber length of 100 nm and an average fiber diameter of 10 nm; and 1.04 parts by mass of graphite were mixed by using a biaxial kneading machine, into which NMP was further added to adjust the viscosity, thereby preparing a positive electrode mixture containing paste. The contents of the PVDF and P(TFE-VDF) in the NMP solution were as follows. Namely, the contents of PVDF and P(TFE-VDF) as dissolved were 2.34 mass % and 0.26 mass %, respectively, in 100 mass % of the total of the mixture of the lithium-containing composite oxide A and LiCoO₂, and the conductive assistants, PVDF and P(TFE-VDF) (namely, the total amounts of the positive electrode mixture layer). In other words, in the above-mentioned positive electrode, the positive electrode mixture layer included binders in total at 2.6 mass %, and the ratio of P(TFE-VDF) was 10 mass % in 100 mass % of the total of P(TFE-VDF) and PVDF.

With adjusting the thickness, the positive electrode mixture containing paste was intermittently applied on both sides of an aluminum foil having a thickness of 15 μm (i.e., the positive electrode current collector). After drying, a calendar process was applied to adjust the overall thickness of the positive electrode mixture layer to become 130 μm. Cutting it with a width of 54.5 mm, a positive electrode was obtained. In addition, a tab serving as a lead part was welded to the exposed part of the aluminum foil as the positive electrode. The density of the positive electrode mixture layer was 3.80 g/cm³ when measured by the method as described before.

### <Preparation of the Negative Electrode>

A composite (*) was provided in which the surface of SiO with an average particle diameter of 8 μm was covered with carbon material. The composite (*) included the carbon material at an amount of 10 mass %. Hereafter, the composite is referred to as “SiO/carbon material composite.” A negative electrode active material was prepared by mixing the composite with graphite having an average particle diameter of 16 μm such that the content of SiO/carbon material composite became 3.0 mass %. 98 parts by mass of the negative electrode active material; 100 parts by mass of a CMC solution having a concentration of 1 mass % and a viscosity of 1500-5000 mPa·s; and 1.0 part by mass of SBR were mixed with a solvent of ion exchange water having a specific resistance of 2.0×10⁵ Ωcm or more to prepare an aqueous negative electrode mixture containing paste.

Adjusting the thickness, the negative electrode mixture containing paste was intermittently applied on both sides of a copper foil having a thickness of 8 μm (i.e., the negative electrode current collector). After drying, a calendar process was applied to adjust the overall thickness of the negative electrode mixture layer to become 110 μm. Cutting it with a width of 55.5 mm, a negative electrode was obtained. In addition, a tab serving as a lead part was welded to the exposed part of the copper foil as a negative electrode.

### <Preparation of Separator>

Into second aggregates of boehmite (5 kg) with an average particle diameter of 3 μm, added were 5 kg of ion exchange water and 0.5 kg of a dispersant (aqueous polycarboxylic acid ammonium salt; solid content of 40 mass %). The mixture was subject to a pulverization treatment using a ball mill with an internal content of 20 L at a rotation rate of 40 rounds/minute for 10 hours, to prepare a dispersion liquid. A part of the dispersion liquid as processed was dried at 120° C. in vacuum. Observing it with a scanning electron microscope (SEM), the shape of the boehmite was shaped in a plate. Also, the average particle diameter of the boehmite as processed was 1 μm.

Into 500 g of the dispersion liquid above, added were 0.5 g of xanthane gum as a viscosity enhancer and 17 g of a resin binder dispersion serving as a binder (i.e., denatured polybutylacrylate; solid content of 45 mass %). The mixture was stirred with a three one motor for 3 hours to obtain a uniform slurry (i.e., the slurry for preparing the porous layer (II); solid content ratio of 50 mass %).

On one surface of a PE porous separator (*) for lithium secondary batteries, applied was a corona discharge treatment (electrical discharge amount: 40 W·min/m²). Here, the PE porous separator (*) is for the porous layer (I) with a thickness of 12 μm, a porosity ratio of 40%, an averaged hole diameter of 0.08 μm and a melting point of PE of 135° C. On the processed surface, the slurry for preparing the porous layer (II) was applied by using a micro gravurev coater. After drying, a porous layer (II) with a thickness of 4 μm was formed to obtain a laminate type separator. The mass per unit area of the porous layer (II) of the separator was 5.5 g/m². The volumetric content of the boehmite was 95 volume %. The porosity ratio was 45%.

### <Assembling of the Battery>

The positive electrode and the negative electrode as obtained above were stacked to each other with the separator interposed such that the porous layer (II) of the separator faced the positive electrode. Wound spirally, a rolled electrode body was obtained. The rolled electrode body as obtained was deformed into a flat shape, which was then put into an exterior can made of an aluminum alloy with a size of 5 mm in thickness, 42 mm in width, and 61 mm in height. The following non-aqueous electrolyte was provided. Namely, a mixture of ethylene carbonate, ethylmethyl carbonate, and diethyl carbonate at a volume ratio=1:1:1 was provided as a solvent. Into the solvent, LiPF₆ was dissolved to become a concentration of 1.1 mol/l. In addition, FEC was added such that its concentration became 2.0 mass %, and VC was added such that its concentration became 1.0 mass %. Furthermore, TEPA was added such that its concentration became 1.0 mass %, to obtain an electrolyte.

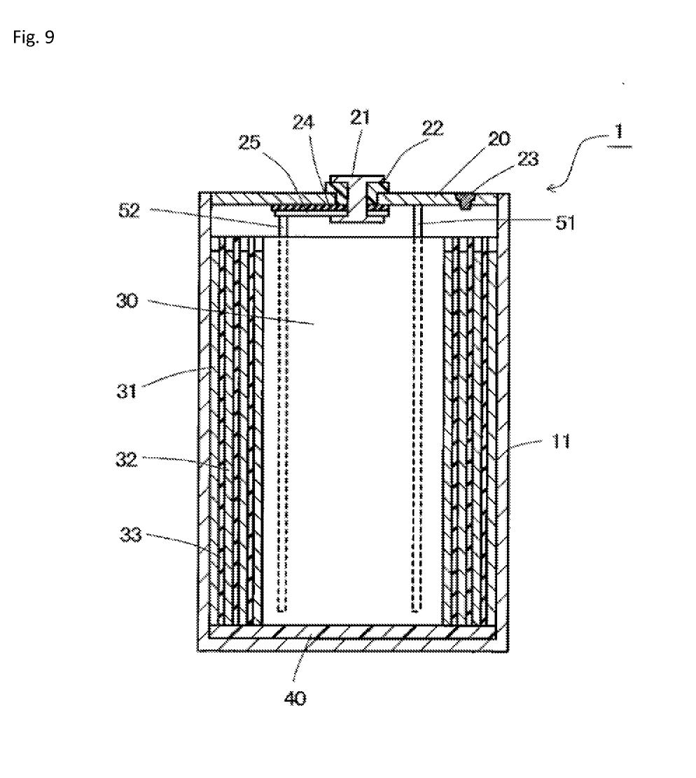

Sealing the exterior can after injecting the non-aqueous electrolyte, a lithium secondary battery was obtained which had an appearance shown in FIGS. 1 and 2, and a structure shown in FIG. 9.

Here, the lithium secondary battery is described with reference to FIGS. 1, 2, and 9. The lithium secondary battery had the cleavable groove 12 to intersect with the diagonal in the side view of the wide surface 111 of the side part of battery case 10 (i.e., exterior can 11). The cleavable groove 12 had a cleavable line with a shape including an inward curved part 121 that projected toward the inside of the side part of the battery case 10 and an outward curved part 122 that projected toward the outside of the side part of the battery case 10. The inward curved part 121 and the outward curved part 122 were almost the same in size, each of which had a semicircle shape. The cleavable line included a pair of these parts to form a character shape. In addition, the connection part of the inward curved part 121 and the outward curved part 122 was located at the part corresponding to the diagonal in the side view of the wide surface 111 of the side part of the battery case 10 (i.e., exterior can 11). Also, a part of the cleavable groove 12, located on the diagonal, was deeper than the other parts thereof, in the side view of the wide surface 111 of the side part of battery case 10 (i.e., exterior can 11).

Also, the lithium secondary battery has the structure as shown in FIG. 9. Namely, the positive electrode 31 and the negative electrode 32 were wound with the separator 33 interposed, and then, the rolled electrode body 30 was deformed into a flat shape. The rolled electrode body 30 was housed inside the exterior can 11 together with the non-aqueous electrolyte. It is, however, noted that for simplification, FIG. 1 does not illustrate the metallic foil serving as a current collector, non-aqueous electrolyte, etc. thought they were used to construct the positive electrode 31 and the negative electrode 32. Also, the layers of the separator are not illustrated therein. In addition, the inner part of the rolled electrode body is not shown as a cross-sectional view.

The exterior can 11 was made of aluminum alloy, which served as a battery case together with the lid 20. The exterior can 11 served as a positive electrode terminal. An insulator 40 made of a PE sheet was provided at the bottom of the exterior can 11. The positive electrode lead body 51 and the negative electrode lead body 52 were drawn from the flat-shaped rolled electrode body 30 including the positive electrode 31, the negative electrode 32 and the separator 33. Each of the bodies 51, 52 was connected to each end of the positive electrode 31 and the negative electrode 32. In addition, the lid 20 made of aluminum alloy (i.e., lid plate for sealing) sealed the opening of the exterior can 11, and was provided with a terminal 21 of a stainless steel via an insulation packing 22 made of PP. The terminal 21 was connected to a lead board 25 made of a stainless steel through an insulator 24.

Then, the lid 20 was inserted into the opening of the exterior can 11, whose jointed portions were welded to each other. As a result, the opening of the exterior can 11 was sealed, and the inside of the battery was sealed. Also, the battery of FIG. 9 had a non-aqueous electrolyte injection port provided on the lid 20. The non-aqueous electrolyte injection port was welded by e.g., laser welding process, in a state where the sealing material 23 inserted therein. As a result, the sealing of the battery was secured.

In the battery of the Example 1, the positive electrode lead body 51 was directly welded to the lid 20 such that the exterior can 11 and the lid 20 could function as a positive electrode terminal. Also, the negative electrode lead body 52 was welded to the lead board 25, such that the negative electrode lead body 52 was conductive to the terminal 21 through the lead board 25, serving the terminal 21 as a negative electrode terminal.

### Examples 2 to 5 and 8

As the positive electrode active material, the mixing ratio of the lithium-containing composite oxide A to LiCoO₂ was changed as shown in Table 1. Other than that, the same processes as used in Example 1 were performed to prepare a positive electrode. The non-aqueous electrolyte was prepared in the same manner as Example 1, except for adding TEPA at an amount shown in Table 2. Except for the notes here, the same processes were carried out as used in Example 1 to prepare a lithium secondary battery.

### Example 6

The lithium-containing composite oxide B was used in place of the lithium-containing composite oxide A to prepare a positive electrode in the same manner as Example 1. The non-aqueous electrolyte was prepared in the same manner as Example 1 except for adding TEPA at an amount shown in Table 2. Except for the notes here, the same processes were carried out as used in Example 1 to prepare a lithium secondary battery.

### Example 7

The same processes as used in Example 1 were carried out except for using the lithium-containing composite oxide C alone as a positive electrode active material to prepare a positive electrode. Except for using the positive electrode, a lithium secondary battery was prepared in the same manner as Example 1.

### Example 9

Except for the change to add acetylene black (2.08 parts by mass) as a conductive assistant, the same processes as used in Example 1 were carried out to prepare a positive electrode. Except for using the positive electrode, a lithium secondary battery was prepared in the same manner as Example 1. The density of the positive electrode mixture layer of the positive electrode was 3.40 g/cm³ when measured by the method as described before.

### Example 10

Except for the change to use PVDF alone as binder, the same processes as used in Example 1 were carried out to prepare a positive electrode. Except for using the positive electrode, a lithium secondary battery was prepared in the same manner as Example 1. The density of the positive electrode mixture layer was 3.60 g/cm³ when measured by the method as described before.

### Examples 11 and 12

Except for the change to add TEPA at an amount shown in Table 2, the same processes as used in Example 1 were carried out to prepare a non-aqueous electrolyte. Except for the change to use this non-aqueous electrolyte, the same processes as used in Example 1 were carried out to prepare a lithium secondary battery.

### Example 13

Except for the change to use graphite having an average particle diameter of 16 μm alone used as the negative electrode active material, the same processes as used in Example 1 were carried out to prepare a negative electrode. Except for the change to use this negative electrode, the same processes as used in Example 1 were carried out to prepare a lithium secondary battery.

### Comparative Example 1

Except for the change to use LiCoO₂ alone as the positive electrode active material, the same processes as used in Example 1 were carried out to prepare a positive electrode. Except for the change to use the positive electrode, the same processes as used in Example 1 were carried out to prepare a lithium secondary battery.

### Comparative Example 2

Except for the change to add TEPA at an amount shown in Table 2, the same processes as used in Example 1 were carried out to prepare a non-aqueous electrolyte.

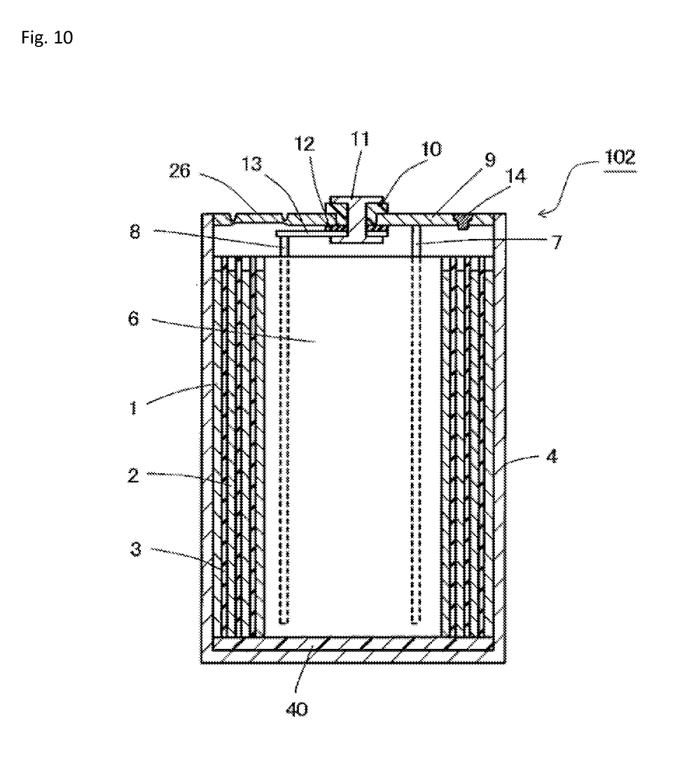

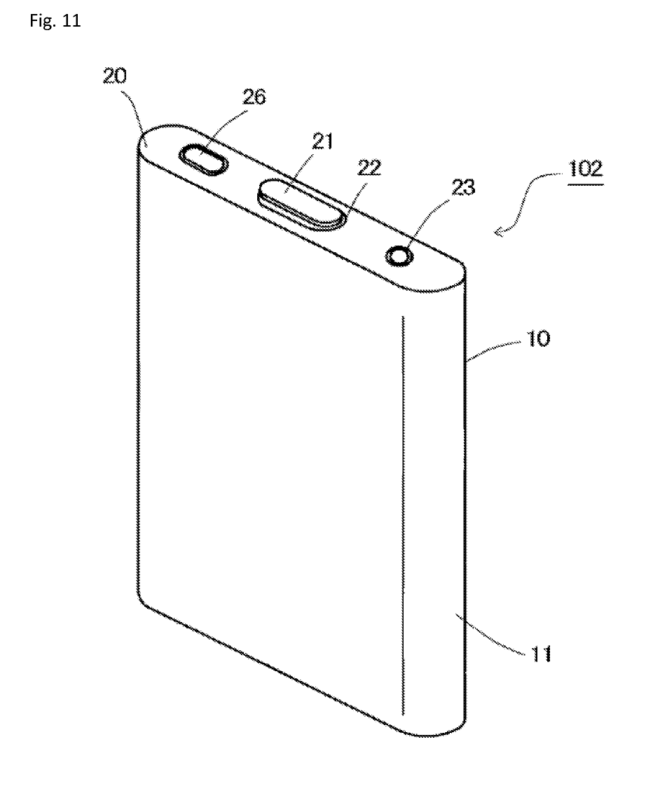

FIGS. 10 and 11 illustrate a partial longitudinal cross-sectional view and an appearance perspective view of the lithium secondary battery of Comparative Example 2. As shown in FIGS. 10 and 11, the lithium secondary battery 102 was provided with an exterior can 11 which did not have the cleavable groove on the side part. The lithium secondary battery 102, however, included the lid 20 having formed a cleavable vent 26 thereon, containing the using the non-aqueous electrolyte as described before. Except for the notes here, the same processes as used in Example 5 were carried out to prepare the lithium secondary battery 102.

### Comparative Example 3

Except for the change to add TEPA at an amount shown in Table 2, the same processes as used in Example 1 were carried out to prepare a non-aqueous electrolyte.

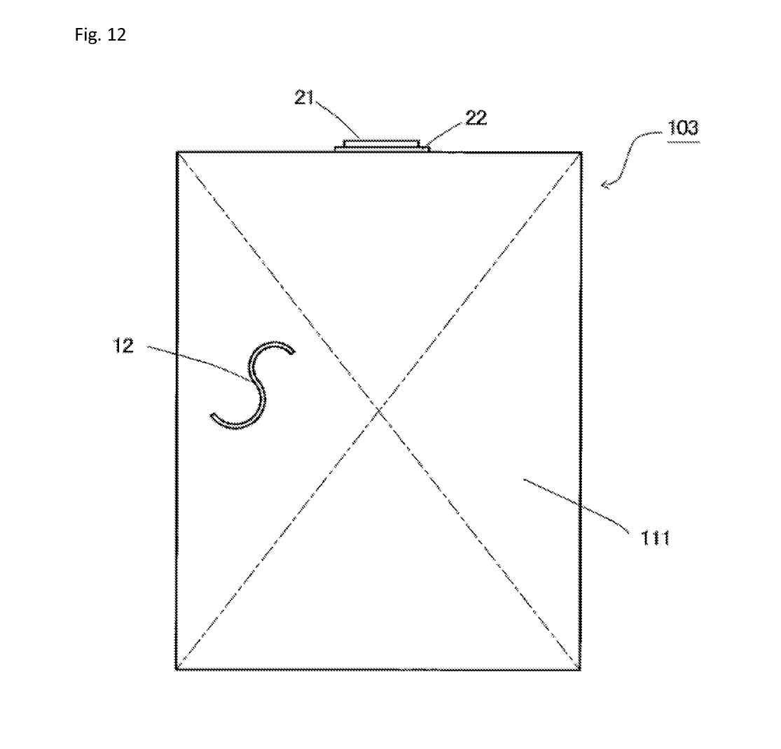

FIG. 12 shows the side view of the lithium secondary battery of Comparative Example 3. As shown in FIG. 12, the exterior can 11 has formed the cleavable groove 12 at the portion on the wide surface 111 as illustrated in the drawing (i.e., the portion not to intersect with the diagonal in the side view of the wide surface 111). The non-aqueous electrolyte as mentioned before was used. Except for the notes here, the same processes as used in Example 5 were carried out to prepare the lithium secondary battery 103.

### Comparative Example 4

Except for the change to use the same battery case as Comparative Example 2 (i.e., the exterior can and the lid), the same processes as used in Comparative Example 1 were carried out to prepared a lithium secondary battery.

The lithium secondary batteries of Examples 1 to 13 and Comparative Example 1 to 4 were evaluated as follows.

### <Battery Capacity>

Each battery of the Examples and the Comparative Examples was applied to an initial charge and discharge, and then, was charged to reach 4.4V at room temperature (25° C.) with a constant current of 1 C. Then, the battery was subject to a constant-current constant-voltage charge process to charge it with a constant voltage of 4.4V (total charging time: 2.5 hours). Then, it was discharged with a constant current discharge of 0.2 C (the discharge stop voltage: 3.0V), and thereby obtained discharge capacity (mAh) was assumed to be the battery capacity. Table 1 shows a relative value (%) which is calculated by dividing the discharge capacity of the Examples and the Comparative Examples by that of the Example 1. Regarding the battery of the Comparative Example 4, the stop voltage in charging was changed into 4.2V, but other than that, the same conditions were used to measure the battery capacity.

### <Battery Swelling>

Each battery of the Examples and the Comparative Examples was applied to the initial charge and discharge, and then, charged in the same condition when the battery capacity was measured. After the charge, the thickness T1 of the battery exterior can was measured. Then, the battery was stored for 24 hours in a constant-temperature bath set at 85° C. After taking out from the constant-temperature bath, the battery was kept at room temperature for three hours, and then, the thickness T2 of the battery exterior can was measured again. In this test, the thickness of the battery exterior can is referred to as the thickness between the wide surfaces of the side part of the exterior can. The measurement of the thickness of the battery exterior was carried out by using a caliper (e.g., made by the Mitsutoyo Corporation; CD-15CX), which was applied to the center part of the wide surface to be measured at a measurement precision of 1/100 mm.

The battery swelling was evaluated based on the change ratio of the exterior can based on the thickness T1 before the 85° C. storage to the thickness T2 after the storage. Namely, the battery swelling (%) was calculated by the following formula: “Battery swelling” (%)=100×(T2−T1)/(T1).

### <Capacity Recovery Rate Regarding the Storage at a High Temperature>

Each battery of the Examples and the Comparative Examples was applied to the initial charge and discharge, and then, charged in the same condition when the battery capacity was measured. After the charge, the battery was applied to a constant current discharge of 0.5 C. The discharge stop voltage was 3.0V. Hereinafter, the discharge stop voltage was used in the same condition. Here, the discharge capacity (mAh) obtained was assumed to be the 0.5 C capacity before the storage. Then, the battery was stored for 24 hours in a constant-temperature bath set at 85° C., and then, taken from the constant-temperature bath and kept at room temperature for three hours. Then, the battery was applied to a constant current discharge of 0.5 C. The battery was charged in the same condition as described above. Then, the battery was applied to a constant current discharge of 0.5 C. Here, the discharge capacity (mAh) obtained was assumed to be the 0.5 C capacity after the storage. From these results, the capacity recovery rate from the 0.5 C capacity before the storage to the 0.5 C capacity after the storage was calculated as follows: “Capacity recovery rate” (%)=100×{(0.5 C capacity after the storage)/(0.5 C capacity before the storage)}

### <Charge Discharge Cycle Characteristics>

Each battery of the Examples and the Comparative Examples was applied to the initial charge and discharge. Then, one cycle is assumed to be a single operation of the charge and the discharge carried out in the same condition as measuring the battery capacity.

The cycle was repeated. The cycle number was examined when the discharge capacity was decreased into 80% of that of the first cycle.

### <150° C. Heating Test A>

Each battery of the Examples and the Comparative Examples was applied to the initial charge and discharge. Then, the battery was charged in the same condition as measuring the battery capacity. Each battery charged was placed in a constant-temperature bath, and heated such that the temperature was raised from 30° C. to 150° C. at a rate of 5° C. per minute. Then, the temperature was maintained at 150° C. for 30 minutes. A thermocouple was used to measure the surface temperature of the battery during the process. The battery was evaluated as “∘ (i.e., safety is excellent)” when the surface temperature was 170° C. or less, whereas battery was evaluated as “x (i.e., safety is inferior),” when the surface temperature exceeded 170° C. as it was in a state of thermal runaway.

Table 1 shows the composition of the positive electrode of the lithium secondary battery of Examples 1 to 13 and Comparative Examples 1 to 4. Table 2 shows the composition of the negative electrode, the composition of the non-aqueous electrolyte (the additive amount of TEPA), and the composition of the cleavable groove. Table 3 shows the results of the evaluations as described before. Also, the symbols of the “cleavable groove” in Table 2 mean the follows. The symbol “1” means that the battery case had the cleavable groove provided on the part to intersect with the diagonal in the side view of the wide surface of the side part thereof. The symbol “2” means that the battery case had the cleavable groove provided on the part not to intersect with the diagonal in the side view of the wide surface of the side part thereof. The symbol “x” means that the side part of the battery case did not have the cleavable groove, but that the lid had the cleavable vent.

TABLE 1

| | Li- | Mass ratio of Li- | | Ni molar |
|---|---|---|---|---|
| | containing | containing | Mass ratio of | ratio in |
| | composite | composite oxide | LiCoO₂ in the | the positive |
| | oxide | including Ni in the | positive | electrode |
| | including | positive electrode | electrode active | active |
| | Ni | active material | material | material |
| Ex. 1 | A | 0.5 | 0.5 | 0.300 |
| Ex. 2 | A | 0.8 | 0.2 | 0.480 |
| Ex. 3 | A | 0.6 | 0.4 | 0.360 |
| Ex. 4 | A | 0.4 | 0.6 | 0.240 |
| Ex. 5 | A | 0.2 | 0.8 | 0.120 |
| Ex. 6 | B | 0.5 | 0.5 | 0.448 |
| Ex. 7 | C | 1.0 | 0 | 0.300 |
| Ex. 8 | A | 0.1 | 0.9 | 0.060 |
| Ex. 9 | A | 0.5 | 0.5 | 0.300 |
| Ex. 10 | A | 0.5 | 0.5 | 0.300 |
| Ex. 11 | A | 0.5 | 0.5 | 0.300 |
| Ex. 12 | A | 0.5 | 0.5 | 0.300 |
| Ex. 13 | A | 0.5 | 0.5 | 0.300 |
| Comp. | None | 0 | 1.0 | 0 |
| Ex. 1 | | | | |
| Comp. | A | 0.2 | 0.8 | 0.120 |
| Ex. 2 | | | | |
| Comp. | A | 0.2 | 0.8 | 0.120 |
| Ex. 3 | | | | |
| Comp. | None | 0 | 1.0 | 0 |
| Ex. 4 | | | | |

TABLE 2

| | Content of | | |
|---|---|---|---|
| | SiO/carbon | | |
| | material | | |
| | composite in | Amount of TEPA | |
| | negative electrode | in non-aqueous | |
| | active material | electrolyte | |
| | (mass %) | (mass %) | Cleavable Groove |
| Ex. 1 | 3 | 1.0 | 1 |
| Ex. 2 | 3 | 3.0 | 1 |
| Ex. 3 | 3 | 3.0 | 1 |
| Ex. 4 | 3 | 2.0 | 1 |
| Ex. 5 | 3 | 2.0 | 1 |
| Ex. 6 | 3 | 5.0 | 1 |
| Ex. 7 | 3 | 1.0 | 1 |
| Ex. 8 | 3 | 0.5 | 1 |
| Ex. 9 | 3 | 1.0 | 1 |
| Ex. 10 | 3 | 1.0 | 1 |
| Ex. 11 | 3 | 0.3 | 1 |
| Ex. 12 | 3 | 0 | 1 |
| Ex. 13 | 0 | 1.0 | 1 |
| Comp. | 3 | 1.0 | 1 |
| Ex. 1 | | | |
| Comp. | 3 | 2.0 | x |
| Ex. 2 | | | |
| Comp. | 3 | 2.0 | 2 |
| Ex. 3 | | | |
| Comp. | 3 | 1.0 | x |
| Ex. 4 | | | |

TABLE 3

| | | | Capacity | | |
|---|---|---|---|---|---|
| | | | recovery | | |
| | Initial | | rate (%) | Cycle | |
| | battery | Battery | after the | number to | 150° C. |
| | capacity | swelling | storage at | reach 80% | heating |
| | (relativity %) | (%) | 85° C. | capacity | test A |
| Ex. 1 | 100 | 5 | 87 | 500 | ∘ |
| Ex. 2 | 140 | 6 | 85 | 490 | ∘ |
| Ex. 3 | 120 | 5 | 86 | 500 | ∘ |
| Ex. 4 | 98 | 4 | 88 | 510 | ∘ |
| Ex. 5 | 96 | 4 | 88 | 510 | ∘ |
| Ex. 6 | 130 | 6 | 86 | 490 | ∘ |
| Ex. 7 | 110 | 7 | 86 | 490 | ∘ |
| Ex. 8 | 95 | 7 | 85 | 500 | ∘ |
| Ex. 9 | 92 | 7 | 85 | 480 | ∘ |
| Ex. 10 | 98 | 6 | 85 | 490 | ∘ |
| Ex. 11 | 98 | 10 | 78 | 450 | ∘ |
| Ex. 12 | 98 | 14 | 77 | 450 | ∘ |
| Ex. 13 | 95 | 4 | 88 | 510 | ∘ |
| Comp. | 88 | 4 | 87 | 500 | ∘ |
| Ex. 1 | | | | | |
| Comp. | 96 | 4 | 88 | 510 | x |
| Ex. 2 | | | | | |
| Comp. | 96 | 4 | 88 | 510 | x |
| Ex. 3 | | | | | |
| Comp. | 88 | 4 | 87 | 500 | ∘ |
| Ex. 4 | | | | | |

The followings are clearly understood from Tables 1 to 3. The lithium secondary batteries of Examples 1 to 13 were provided with the positive electrode active material made of a Li-containing composite oxide including Ni as transition metal, as well as the cleavable groove provided at an appropriate location of the battery case. By contrast, the battery of Comparative Example 4 used LiCoO₂ alone as the positive electrode active material, and it was charged with the stop voltage, that was equivalent to that of the conventional lithium secondary batteries. The lithium secondary battery of Example 1 to 13 were superior to the battery of Comparative Example 4, in view of the high capacity, and in view of the safety under excessive high temperature since the thermal runaway was properly suppressed by the cleavable groove appropriately operated when heated at 150° C.

By contrast, the battery of Comparative Example 1 included a positive electrode active material that does not contain Ni as transition metal, and therefore, it was inferior in the capacity. Also, the batteries of Comparative Examples 2 and 3 were inappropriate because of the locations of the cleavable vent and the cleavable groove provided on the battery case. The batteries of Comparative Examples 2 and 3 did not appropriately operate the cleavable vent and the cleavable groove when heated at 150° C., thereby causing the thermal runaway to increase the surface temperature.

As explained above, the battery of Comparative example 4 used LiCoO₂ as the positive electrode active material, and charged with the stop voltage equivalent to that of the conventional lithium secondary batteries. The cleavable vent did not operate when heated at 150° C. since the cleavable vent was provided on the lid. However, because Ni was not included in the positive electrode active material, and because of the low stop voltage charge, and because of the separator having both the shutdown characteristic and the heat-shrinkage resistance characteristic, the thermal runaway could be suppressed.

The lithium secondary batteries of Examples 1 to 10 and 13 used the non-aqueous electrolyte in which the phosphonoacetate compound of the general formula (2) was contained at a suitable amount. The amount of the phosphonoacetate compound was not suitable in the lithium secondary batteries of Examples 11 and 12. The lithium secondary batteries of Examples 1 to 10 and 13 were superior to the lithium secondary batteries of Examples 11 and 12 in view of having improved the capacity recovery rate after the storage at 85° C., the suppression of the battery swelling, improved the storage property, enhanced the cycle number to reach the 80% capacity, and improved the charge discharge cycle characteristics.

### Example 14

A separator for lithium secondary batteries was changed into a separator made by laminating a PE fine porous film and a PP fine porous film (thickness of 16 μm, porosity rate of 40%, average pore size of 0.08 μm, PE having a melting point of 135° C., and PP having a melting point of 165° C.). Except for the change above, the same processes as used in Example 1 were carried out to prepare a lithium secondary battery.

### Examples 15 to 18 and 21

Except for the change to prepare a positive electrode active material at a mixing ratio of the lithium-containing composite oxide A to LiCoO₂ as shown in Table 4, the same processes as used in Example 1 were carried out to prepare a positive electrode. Except for the change to prepare a non-aqueous electrolyte at an amount of TEPA as shown in Table 5, the same processes as used in Example 1 were carried out to prepare a non-aqueous electrolyte. Other than the notes here, the same processes as used in Example 14 were carried out to prepare a lithium secondary battery.

### Example 19

The lithium-containing composite oxide B was used in place of the lithium-containing composite oxide A to prepare a positive electrode in the same manner as Example 1. Except for the change to prepare a non-aqueous electrolyte at an amount of TEPA as shown in Table 5, the same processes as used in Example 1 were carried out to prepare a non-aqueous electrolyte. Other than the notes here, the same processes as used in Example 14 were carried out to prepare a lithium secondary battery.

### Example 20

Except for the change to use the lithium-containing composite oxide C alone as the positive electrode active material, the same processes as used in Example 1 were carried out to prepare a positive electrode. Except for the change to use this positive electrode, the same processes as used in Example 14 were carried out to prepare a lithium secondary battery.

### Example 22

Except for the change to add acetylene black (2.08 parts by mass) as a conductive assistant, the same processes as used in Example 1 were carried out to prepare a positive electrode. Except for the change to use this positive electrode, the same processes as used in Example 14 were carried out to prepare a lithium secondary battery. The density of the positive electrode mixture layer of the positive electrode was 3.40 g/cm³ when measured by the method as described before.

### Example 23

Except for the change to use PVDF alone as a binder, the same processes as used in Example 1 were carried out to prepare a positive electrode. Except for the change to use this positive electrode, the same processes as used in Example 14 were carried out to prepare a lithium secondary battery. The density of the positive electrode mixture layer was 3.60 g/cm³ when measured by the method as described before.

### Examples 24 and 25

Except for the change to prepare a non-aqueous electrolyte at an amount of TEPA as shown in Table 5, the same processes as used in Example 1 were carried out to prepare a non-aqueous electrolyte. Except for the change to use this non-aqueous electrolyte, the same processes as used in Example 14 were carried out to prepare a lithium secondary battery.

### Comparative Example 5

Except for the change to use LiCoO₂ alone as the positive electrode active material, the same processes as used in Example 1 were carried out to prepare a positive electrode. Except for the change to use this positive electrode, the same processes as used in Example 14 were carried out to prepare a lithium secondary battery.

### Comparative Example 6

Except for the change to prepare a non-aqueous electrolyte at an amount of TEPA as shown in Table 5, the same processes as used in Example 1 were carried out to prepare a non-aqueous electrolyte. Except for the change to use this non-aqueous electrolyte and the same battery case as used in Comparative Example 2 (i.e., the exterior can and the lid), the same processes as used in Example 18 were carried out to prepare a lithium secondary battery.

### Comparative Example 7

Except for the change to add TEPA at an amount shown in Table 5, the same processes as used in Example 14 were carried out to prepare a non-aqueous electrolyte. Except for the change to use this non-aqueous electrolyte and the same battery case as used in Comparative Example 3 (i.e., the exterior can and the lid), the same processes as used in Example 18 were carried out to prepare a lithium secondary battery.

With respect to the lithium secondary batteries of Example 14 to 25 and Comparative Examples 5 to 7, the same evaluations as used in the lithium secondary battery of Example 1 were carried out to assess the battery capacity, the battery swelling, the capacity recovery rate after the storage at a high temperature, and the charge discharge cycle characteristics. Also, with respect to the lithium secondary batteries of Example 14 to 25 and Comparative Examples 5 to 7, the vent operation when heated at 150° C. was evaluated by the following method.

<Evaluation of the Vent Operation when Heating at 150° C.>

Each battery of the Examples and the Comparative Examples was applied to the initial charge and discharge. Then, the battery was charged in the same condition as measuring the battery capacity. Each battery charged was put in a constant-temperature bath, and heated such that the temperature was raised from 30° C. to 150° C. at a rate of 5° C. per minute, and then, maintained at 150° C. A thermocouple was used to measure the surface temperature of the battery during the heating and the maintenance at 150° C. The surface temperature of batteries usually reached an equilibrium state at about 150° C. However, when the vents are operated such that the cleavable groove provided on the battery case or the cleavable vent provided on the lid is cleaved to release gases inside the battery, the surface temperature of the battery can decrease slightly. Thus, the vent was assumed to have been operated when the surface temperature of the battery decreased from the equilibrium temperature by 2° C. or more. Also, the operation start time of the vent was assumed to be the duration from the time when reaching the equilibrium temperature to the time when the temperature started to decrease. However, it was assumed that the upper limit of the operation start time of the vent was 40 minutes; if no vent operation had started within the duration, it was assumed that there was no vent operation.

Table 4 shows the composition of the positive electrode of the lithium secondary battery of the Examples and the Comparative Examples. Table 5 shows the composition of the negative electrode, the composition of the non-aqueous electrolyte (the additive amount of TEPA), and the composition of the cleavable groove. Table 6 shows the results of the evaluations as described before. In Table 5, the symbol “1” means that the battery case had the cleavable groove provided on the part to intersect with the diagonal in the side view of the wide surface of the side part thereof. The symbol “2” means that the battery case had the cleavable groove provided on the part not to intersect with the diagonal in the side view of the wide surface of the side part thereof. The symbol “x” means that the side part of the battery case did not have the cleavable groove, but that the lid had the cleavable vent.

TABLE 4

| | | Mass ratio of | | |
|---|---|---|---|---|
| | Li | amount of Li | | Ni molar |
| | containing | containing | mass ratio of | ratio in all |
| | composite | composite oxide | LiCoO₂ in the | the positive |
| | oxide | including Ni in the | positive | electrode |
| | including | positive electrode | electrode active | active |
| | Ni | active material | material | material |
| Ex. 14 | A | 0.5 | 0.5 | 0.300 |
| Ex. 15 | A | 0.8 | 0.2 | 0.480 |
| Ex. 16 | A | 0.6 | 0.4 | 0.360 |
| Ex. 17 | A | 0.4 | 0.6 | 0.240 |
| Ex. 18 | A | 0.2 | 0.8 | 0.120 |
| Ex. 19 | B | 0.5 | 0.5 | 0.448 |
| Ex. 20 | C | 1.0 | 0 | 0.300 |
| Ex. 21 | A | 0.1 | 0.9 | 0.060 |
| Ex. 22 | A | 0.5 | 0.5 | 0.300 |
| Ex. 23 | A | 0.5 | 0.5 | 0.300 |
| Ex. 24 | A | 0.5 | 0.5 | 0.300 |
| Ex. 25 | A | 0.5 | 0.5 | 0.300 |
| Comp. | None | 0 | 1.0 | 0 |
| Ex. 5 | | | | |
| Comp. | A | 0.2 | 0.8 | 0.120 |
| Ex. 6 | | | | |
| Comp. | A | 0.2 | 0.8 | 0.120 |
| Ex. 7 | | | | |

TABLE 5

| | Content of | | |
|---|---|---|---|
| | SiO/carbon | | |
| | material | Amount of TEPA | |
| | composite in the | in the non- | |
| | negative electrode | aqueous | |
| | active material | electrolyte | |
| | (mass %) | (mass %) | Cleavable groove |
| Ex. 14 | 3 | 1.0 | 1 |
| Ex. 15 | 3 | 3.0 | 1 |
| Ex. 16 | 3 | 3.0 | 1 |
| Ex. 17 | 3 | 2.0 | 1 |
| Ex. 18 | 3 | 2.0 | 1 |
| Ex. 19 | 3 | 5.0 | 1 |
| Ex. 20 | 3 | 1.0 | 1 |
| Ex. 21 | 3 | 0.5 | 1 |
| Ex. 22 | 3 | 1.0 | 1 |
| Ex. 23 | 3 | 1.0 | 1 |
| Ex. 24 | 3 | 0.3 | 1 |
| Ex. 25 | 3 | 0 | 1 |
| Comp. | 3 | 1.0 | 1 |
| Ex. 5 | | | |
| Comp. | 3 | 2.0 | x |
| Ex. 6 | | | |
| Comp. | 3 | 2.0 | 2 |
| Ex. 7 | | | |

TABLE 6

| | | | Capacity | | Time to start |
|---|---|---|---|---|---|
| | | | recovery | | the vent |
| | Initial | | rate (%) | Cycle | operation in |
| | battery | Battery | after the | number to | heating at |
| | capacity | swelling | storage at | reach 80% | 150° C. |
| | (relativity %) | (%) | 85° C. | capacity | (minutes) |
| Ex. 14 | 100 | 5 | 87 | 500 | 15 |
| Ex. 15 | 140 | 6 | 85 | 490 | 15 |
| Ex. 16 | 120 | 5 | 86 | 500 | 15 |
| Ex. 17 | 98 | 4 | 88 | 510 | 25 |
| Ex. 18 | 96 | 4 | 88 | 510 | 30 |
| Ex. 19 | 130 | 6 | 86 | 490 | 15 |
| Ex. 20 | 110 | 7 | 86 | 490 | 15 |
| Ex. 21 | 95 | 7 | 85 | 500 | 30 |
| Ex. 22 | 92 | 7 | 85 | 480 | 15 |
| Ex. 23 | 98 | 6 | 85 | 490 | 15 |
| Ex. 24 | 98 | 10 | 78 | 450 | 20 |
| Ex. 25 | 98 | 14 | 77 | 450 | 20 |
| Comp. | 88 | 4 | 87 | 500 | 40 |
| Ex. 5 | | | | | |
| Comp. | 96 | 4 | 88 | 510 | Not operated |
| Ex. 6 | | | | | |
| Comp. | 96 | 4 | 88 | 510 | Not operated |
| Ex. 7 | | | | | |

The followings are clearly understood from Tables 4 to 6. The lithium secondary batteries of Example 14-25 had the following features. These batteries included lithium-containing composite oxide (Li-containing compound oxide) including Ni having a specific composition. The positive electrode included the positive electrode active material having properly adjusted Ni molar ratio in all the positive electrode active materials. The negative electrode included SiOₓ and graphite carbon material as a negative electrode active material. Furthermore, the cleavable groove was provided on an appropriate location of the battery case. The lithium secondary batteries of Examples 14 to 25 had a high capacity and good safety since the time to start the vent operation was short.

On the other hand, the battery of Comparative Example 5 used LiCoO₂ alone as the positive electrode active material. The battery of Comparative Example 5 was inferior in the capacity, and had a long time to start the vent operation. Furthermore, the batteries of Comparative Examples 6 and 7 were improper because of the locations of the cleavable vent and the cleavable groove provided on the battery case. The batteries of Comparative Examples 6 and 7 did not operate the vent within 40 minutes. Although the batteries of Comparative Example 5 to 7 were not found in an abnormal operation such as explosion or ignition, it required a longer time to start the vent operation. Therefore, it could cause thermal shrinkages of the separator, making contacts between the positive and negative electrodes and causing the internal short-cut. Thus, these batteries cannot be said to have sufficient margin for the safety at a high temperature.

The lithium secondary batteries of Examples 14 to 23 used the non-aqueous electrolyte in which the phosphonoacetate compound of the general formula (2) was contained at a suitable amount. The amount of the phosphonoacetate compound was not suitable in the lithium secondary batteries of Examples 24 and 25. The lithium secondary batteries of Examples 14 to 23 were superior to the lithium secondary batteries of Examples 14 and 25 in view of having improved the capacity recovery rate after the storage at 85° C., suppressed of the battery swelling, improved the storage property, enhanced the cycle number to reach the 80% capacity, and improved the charge discharge cycle characteristics.

### Example 26

Except for the change to prepare a positive electrode active material at a mixing ratio of the lithium-containing composite oxide A to LiCoO₂ as shown in Table 8, the same processes as used in Example 1 were carried out to prepare a positive electrode. Except for the change to prepare a negative electrode active material at a content of SiO/carbon material composite as shown in Table 7, the same processes as used in Example 1 were carried out to prepare a negative electrode. Except for the change to add TEPA and FEC at amounts shown in Table 7, the same processes as used in Example 1 were carried out to prepare a non-aqueous electrolyte.

Then, except for the change to use the positive electrode, the negative electrode and the non-aqueous electrolyte as mentioned above, the same processes as used in Example 1 were carried out to prepare a lithium secondary battery.

### Examples 27 and 28

Except for the change to prepare a positive electrode active material at a mixing ratio of the lithium-containing composite oxide A to LiCoO₂ as shown in Table 8, the same processes as used in Example 1 were carried out to prepare a positive electrode. Except for the change to use this positive electrode, the same processes as used in Example 26 were carried out to prepare a lithium secondary battery.

### Example 29

Except for the change to add FEC at an amount shown in Table 7, the same processes as used in Example 1 were carried out to prepare a non-aqueous electrolyte. Except for the change to use this non-aqueous electrolyte, the same processes as used in Example 26 were carried out to prepare a lithium secondary battery.

### Example 30

Except for the changes to replace the lithium-containing composite oxide A with the lithium-containing composite oxide B and to prepare a positive electrode active material including the lithium-containing composite oxide B and LiCoO₂ at a mixing ratio as shown in Table 8, the same processes as used in Example 1 were carried out to prepare a positive electrode. Also, except for the change to prepare a negative electrode active material at a content of SiO/carbon material composite as shown in Table 7, the same processes as used in Example 1 were carried out to prepare a negative electrode. Furthermore, except for the change to add TEPA and FEC at amounts shown in Table 7, the same processes as used in Example 1 were performed to prepare a non-aqueous electrolyte.

Then, except for the change to use the positive electrode, the negative electrode and the non-aqueous electrolyte as mentioned above, the same processes as used in Example 1 were carried out to prepare a lithium secondary battery.

### Example 31 and Comparative Examples 9 and 10

Except for the change to prepare a negative electrode active material at a content of SiO/carbon material composite as shown in Table 7, the same processes as used in Example 1 were carried out to prepare a negative electrode. Except for the change to add TEPA and FEC at amounts shown in Table 7, the same processes as used in Example 1 were performed to prepare a non-aqueous electrolyte.

Then, except for the change to use the negative electrode and the non-aqueous electrolyte as mentioned above, the same processes as used in Example 26 were carried out to prepare a lithium secondary battery.

### Comparative Example 8

Except for excluding FEC, the same processes as used in Example 26 were carried out to prepare a non-aqueous electrolyte. Except for the change to use this non-aqueous electrolyte, the same processes as used in Example 26 were carried out to prepare a lithium secondary battery.

### Comparative Example 11

Except for the change to use the same battery case as used in Comparative Example 2 (i.e., the exterior can and the lid), the same processes as used in Example 26 were carried out to prepared a lithium secondary battery.

### Comparative Example 12

Except for the change to use graphite having an average particle diameter of 16 μm alone as a negative electrode active material, the same processes as used in Example 26 were carried out to prepare a negative electrode. Except for the change to use this negative electrode, the same processes as used in Comparative Example 1 were carried out to prepare a lithium secondary battery.

### Comparative Example 13

Except for the change to use the same battery case as used in Comparative Example 3 (i.e., the exterior can and the lid), the same processes as used in Example 26 were carried out to prepared a lithium secondary battery.

With respect to the lithium secondary batteries of Example 26 to 31 and Comparative Examples 8 to 13, the same evaluations as used in the lithium secondary battery of Example 1 were carried out to assess the battery capacity, the battery swelling, the capacity recovery rate after the storage at a high temperature, the charge discharge cycle characteristics. Also, with respect to the lithium secondary batteries of Example 26 to 31 and Comparative Examples 8 to 13, a 150° C. heating test B was carried out by the method as explained below.

### <150° C. Heating Test B>

Each battery of the Examples and the Comparative Examples was applied to the initial charge and discharge. Then, the battery was charged in the same condition as measuring the battery capacity. Each battery charged was placed in a constant-temperature bath, and heated such that the temperature was raised from 30° C. to 150° C. at a rate of 5° C. per minute, and then, maintained at 150° C. A thermocouple was used to measure the surface temperature of the battery during the heating and the maintenance at 150° C. The surface temperature of batteries usually reaches an equilibrium state at about 150° C. However, when the vents are operated such that the cleavable groove provided on the battery case or the cleavable vent provided on the lid is cleaved to release gases inside the battery, the surface temperature of the battery can decrease slightly. Thus, the vent was assumed to have been operated when the surface temperature of the battery decreased from the equilibrium temperature by 2° C. or more. Also, the start time of the vent operation was assumed to be the duration from the time when reaching the equilibrium temperature to the time when the temperature started to decrease. Then, a battery was evaluated as “∘ (i.e., excellent safety)” when the start time of the vent operation was within 30 minutes. By contrast, a battery was evaluated as “x (i.e., inferior safety)” when the start time of the vent operation was more than 30 minutes.

With respect to the lithium secondary batteries of Examples 26 to 31 and Comparative Examples 8 to 13, Table 7 shows the composition of the negative electrode, the composition of the non-aqueous electrolyte (amounts of FEC and TEPA), and the structure of the cleavable groove. Table 8 shows the composition of the positive electrode. Table 9 shows the results of the evaluations as described before.

Also, the symbols of the “cleavable groove” in Table 7 mean the follows. The symbol “1” means that the battery case had the cleavable groove provided on the part to intersect with the diagonal in the side view of the wide surface of the side part thereof. The symbol “2” means that the battery case had the cleavable groove provided on the part not to intersect with the diagonal in the side view of the wide surface of the side part thereof. The symbol “x” means that the side part of the battery case did not have the cleavable groove, but that the lid has the cleavable vent.

TABLE 7

| | | |
|---|---|---|
| Content of | | |
| SiO/carbon | Amount | |
| material | in the | |
| composite in the | non-aqueous | |
| negative electrode | electrolyte | |
| active material | (mass %) | Cleavable |

| | (mass %) | FEC | TEPA | groove |
|---|---|---|---|---|
| Ex. 26 | 5 | 1.0 | 1.0 | 1 |
| Ex. 27 | 5 | 1.0 | 1.0 | 1 |
| Ex. 28 | 5 | 1.0 | 1.0 | 1 |
| Ex. 29 | 5 | 0.5 | 1.0 | 1 |
| Ex. 30 | 1 | 2.0 | 5.0 | 1 |
| Ex. 31 | 20 | 5.0 | 5.0 | 1 |
| Comp. | 5 | 0 | 1.0 | 1 |
| Ex. 8 | | | | |
| Comp. | 20 | 7.0 | 5.0 | 1 |
| Ex. 9 | | | | |
| Comp. | 30 | 5.0 | 5.0 | 1 |
| Ex. 10 | | | | |
| Comp. | 5 | 1.0 | 1.0 | x |
| Ex. 11 | | | | |
| Comp. | 0 | 1.0 | 1.0 | x |
| Ex. 12 | | | | |
| Comp. | 5 | 1.0 | 1.0 | 2 |
| Ex. 13 | | | | |

TABLE 8

| | Li- | Mass ratio of the | | Ni molar |
|---|---|---|---|---|
| | containing | Li-containing | Mass ratio of | ratio in |
| | composite | composite oxide | LiCoO₂ in the | the positive |
| | oxide | including Ni in the | positive | electrode |
| | including | positive electrode | electrode active | active |
| | Ni | active material | material | material |
| Ex. 26 | A | 0.2 | 0.8 | 0.120 |
| Ex. 27 | A | 0.3 | 0.7 | 0.180 |
| Ex. 28 | A | 0.4 | 0.6 | 0.240 |
| Ex. 29 | A | 0.2 | 0.8 | 0.120 |
| Ex. 30 | B | 0.5 | 0.5 | 0.448 |
| Ex. 31 | A | 0.2 | 0.8 | 0.120 |
| Comp. | A | 0.2 | 0.8 | 0.120 |
| Ex. 8 | | | | |
| Comp. | A | 0.2 | 0.8 | 0.120 |
| Ex. 9 | | | | |
| Comp. | A | 0.2 | 0.8 | 0.120 |
| Ex. 10 | | | | |
| Comp. | A | 0.2 | 0.8 | 0.120 |
| Ex. 11 | | | | |
| Comp. | A | 0.2 | 0.8 | 0.120 |
| Ex. 12 | | | | |
| Comp. | A | 0.2 | 0.8 | 0.120 |
| Ex. 13 | | | | |

TABLE 9

| | | | Capacity | | |
|---|---|---|---|---|---|
| | | | recovery | | |
| | Initial | | rate (%) | Cycle | |
| | battery | Battery | after the | number to | |
| | capacity | swelling | storage at | reach 80% | 150° C. |
| | (relativity %) | (%) | 85° C. | capacity | heating test B |
| Ex. 26 | 100 | 4 | 88 | 510 | ∘ |
| Ex. 27 | 101 | 4 | 88 | 505 | ∘ |
| Ex. 28 | 102 | 5 | 87 | 505 | ∘ |
| Ex. 29 | 100 | 3 | 88 | 490 | ∘ |
| Ex. 30 | 126 | 5 | 88 | 500 | ∘ |
| Ex. 31 | 120 | 14 | 78 | 490 | ∘ |
| Comp. | 100 | 3 | 88 | 350 | x |
| Ex. 8 | | | | | |
| Comp. | 120 | 20 | 72 | 535 | ∘ |
| Ex. 9 | | | | | |
| Comp. | 130 | 25 | 70 | 390 | ∘ |
| Ex. 10 | | | | | |
| Comp. | 100 | 4 | 88 | 510 | x |
| Ex. 11 | | | | | |
| Comp. | 89 | 4 | 88 | 510 | x |
| Ex. 12 | | | | | |
| Comp. | 100 | 4 | 88 | 510 | x |
| Ex. 13 | | | | | |

The followings are clearly understood from Tables 7 to 9. The lithium secondary batteries of Examples 26 to 31 had the following features. As the negative electrode active material, a composite of SiOₓ and carbon material was used in combination with graphite carbon material, such that the ratio of the composite was proper. Moreover, the non-aqueous electrolyte included a halogen-substituted cyclic carbonate (FEC) with a proper content. Furthermore, the cleavable groove was appropriately provided on the specific location of the battery case. The lithium secondary batteries of Examples 26 to 31 had a high capacity and were excellent in safety under excessive high temperature since when heated at 150° C., the time to start the vent operation was short. In addition, lithium secondary batteries of Examples 26 to 31 have swollen a little after the storage at 85° C. These batteries showed an improved capacity recovery rate, and excellent storage property.

By contrast, the battery of Comparative Example 8 used the non-aqueous electrolyte without FEC contained. The batteries of Comparative Examples 11 to 13 were improper in the locations of the cleavable vent and the cleavable groove on the battery case. These batteries took relatively a long time to start the vent operation when the 150° C. heating test. There was not found abnormal operation such as explosion or ignition in the 150° C. heating test, but in case of using a separator low in heat resistance (i.e., separator that is easily subject to heat shrinkage), a long time to start vent operation can make heat shrinkage of the separator, thereby making contacts between the positive and negative electrodes to cause internal short-cut. Therefore, these batteries cannot be said to have a sufficient margin for the safety at a high temperature.

Also, the battery of Comparative Example 9 used the non-aqueous electrolyte including an excess amount of FEC. The battery of Comparative Example 12 included the negative electrode active material with an excess content ratio of the composite. These batteries were largely swollen after the storage at 85° C. These batteries had a low capacity recovery rate, and were inferior in the storage property.

The present invention can be practiced as other embodiments as described here, without departing the gist of the invention. The embodiments as described in this application are examples only, and the present invention is not limited to these embodiments. The scope of the present invention should be construed based on the claims rather than the detailed description in the specification. Any variations within the scope of the claims and its equivalence should be covered by the claims of the present invention.

What is claimed is:

1. A lithium secondary battery, comprising:
a battery case shaped in a hollow column, the battery case enclosing a positive electrode, a negative electrode, a non-aqueous electrolyte, and a separator,
wherein the positive electrode comprising a positive electrode mixture layer comprising a positive electrode active material, a conductive assistant and a binder on one side or both sides of a current collector,
wherein the positive electrode active material comprises a lithium-containing composite oxide comprising lithium and a transition metal, wherein at least a part of the lithium-containing composite oxide includes nickel as the transition metal,
wherein when manufacturing the lithium secondary battery, the non-aqueous electrolyte includes a halogen-substituted cyclic carbonate at a content of 0.5 to 5 mass %,
wherein the side part of the battery case includes two wide surfaces opposed to each other,
wherein the two wide surfaces are wider than the other surfaces in a side view thereof,
wherein the side part has such a cleavable groove that is cleaved when an internal pressure of the battery exceeds a threshold,
wherein the cleavable groove is provided at a portion to intersect with a diagonal of the wide surfaces in the side view.

2. The lithium secondary battery of claim 1, wherein prior to use, the lithium secondary battery is applied to a constant-current constant-voltage charge with a stop voltage of more than 4.30V.

3. The lithium secondary battery of claim 1, wherein the lithium-containing composite oxide including nickel as the transition metal is included at a content of 10 to 80 mass % in all the positive electrode active material.

4. The lithium secondary battery of claim 1, wherein at least a part of the lithium-containing composite oxide including nickel as the transition metal has the following general composition formula (1):
Li_{1+y}MO₂ (1)
wherein the general composition formula (1) satisfies −0.15≦y≦0.15,
wherein M represents an element group of three or more kinds, the element group at least including Ni, Co and Mn, and
wherein 25≦a≦90, 5≦b≦35, 5≦c≦35 and 10≦b+c≦70 are satisfied in which a, b and c represent ratios (mol %) of Ni, Co and Mn in the element group of M, respectively.

5. The lithium secondary battery of claim 1, wherein the positive electrode mixture layer comprises, as the conductive assistant, a carbon fiber with an average fiber length of 10 to 1000 nm and an average fiber diameter of 1 to 100 nm; wherein a content of the carbon fiber in the positive electrode mixture layer is 0.25 to 1.5 mass %.

6. The lithium secondary battery of claim 1, wherein the positive electrode mixture layer comprises, as the binder, a tetrafluoroethylene-vinylidene fluoride copolymer and a vinylidene fluoride polymer, wherein the vinylidene fluoride polymer is different from the tetrafluoroethylene-vinylidene fluoride copolymer and is made mainly from a monomer of vinylidene fluoride,
wherein a total content of the binder in the positive electrode mixture layer is 2.5 to 4 parts by mass,
wherein in 100 mass % of the total of the tetrafluoroethylene-vinylidene fluoride copolymer and the vinylidene fluoride polymer, a ratio of the tetrafluoroethylene-vinylidene fluoride copolymer is 10 mass % or more.

7. The lithium secondary battery of claim 1, wherein the negative electrode comprises a negative electrode mixture layer comprising a negative electrode active material, the negative electrode active material comprising:
a material including Si and O as constituent elements (wherein an atom ratio x of O to Si is 0.5≦x≦1.5); and
graphite carbon,
wherein the negative electrode mixture layer is provided on one side or both sides of a current collector.

8. The lithium secondary battery of claim 7, wherein the negative electrode active material comprises a composite of the material including Si and O as constituent elements, in combination with a carbon material.

9. The lithium secondary battery of claim 1, wherein the separator comprises:
a porous layer (I) mainly composed of a thermoplastic resin, and
a porous layer (II) mainly composed of a filler with a heat resistance temperature of 150° C. or more.

10. The lithium secondary battery of claim 1, wherein, when manufacturing the lithium secondary battery, the non-aqueous electrolyte comprises vinylene carbonate.

11. The lithium secondary battery of claim 1, wherein, when manufacturing the lithium secondary battery, the non-aqueous electrolyte comprises a phosphonoacetate compound represented by the following general formula (2). 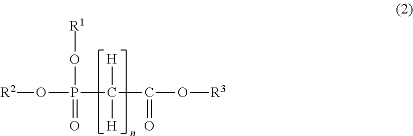
wherein in the general formula (2), each of R¹ to R³ independently represents an alkyl group, alkenyl group or alkynyl group with a carbon number of 1 to 12, with or without a halogen substituent, and n represents an integer of 0 to 6.

12. A lithium secondary battery, comprising:
a battery case shaped in a hollow column, the battery case enclosing a positive electrode a negative electrode, a non-aqueous electrolyte, and a separator,
wherein the positive electrode comprising a positive electrode mixture layer comprising a positive electrode active material, a conductive assistant and a binder, the positive electrode mixture layer provided on one side or both sides of a current collector,
wherein the positive electrodeactive material comprises a lithium-containing composite oxide represented by the following general composition formula (1):
Li_{1+y}MO₂ (1)
wherein the general composition formula (1) satisfies −0.15≦y≦0.15,
wherein M represents an element group of three or more kinds, the element group including at least Ni, Co and Mn, and
wherein 25≦a≦90, 5≦b≦35, 5≦c≦35 and 10≦b+c≦70 are satisfied in which a, b and c represent ratios (mol %) of Ni, Co and Mn in the elements of M, respectively
wherein in all of the positive electrodeactive material, a molar ratio of all Ni in all metals excluding Li is 0.05 to 0.5,
wherein the negative electrode comprises a negative electrode mixture layer comprising a negative electrode active material comprising: a material including Si and O as constituent elements (wherein an atom ratio x of O to Si is 0.5≦x≦1.5); and graphite carbon, wherein the negative electrode mixture layer is provided on one side or both sides of a current collector,
wherein when manufacturing the lithium secondary battery, the non-aqueous electrolyte comprises a halogen-substituted cyclic carbonate at a content of 0.5 to 5 mass %,
wherein the side part of the battery case includes two wide surfaces opposed to each other,
wherein the two wide surfaces are wider than the other surfaces in a side view thereof,
wherein the side part has such a cleavable groove that is cleaved when an internal pressure of the battery exceeds a threshold,
wherein the cleavable groove is provided at a portion to intersect with a diagonal of the wide surfaces in the side view.

13. The lithium secondary battery of claim 12, wherein prior to use, the lithium secondary battery is applied to a constant current and constant voltage charge with a stop voltage of more than 4.30V.

14. The lithium secondary battery of claim 12, wherein the negative electrode active material comprises a composite of the material including Si and O as constituent elements, in combination with a carbon material.

15. The lithium secondary battery of claim 12, wherein the positive electrode mixture layer comprises, as the conductive assistant, a carbon fiber with an average fiber length of 10 to 1000 nm and an average fiber diameter of 1 to 100 nm; wherein a content of the carbon fiber in the positive electrode mixture layer is 0.25 to 1.5 mass %.

16. The lithium secondary battery of claim 12, wherein the positive electrode mixture layer comprises, as the binder, a tetrafluoroethylene-vinylidene fluoride copolymer and a vinylidene fluoride polymer, wherein the vinylidene fluoride polymer is different from the tetrafluoroethylene-vinylidene fluoride copolymer and is mainly made from a monomer of vinylidene fluoride,
wherein a total content of the binder in the positive electrode mixture layer is 2.5 to 4 parts by mass,
wherein in 100 mass % of the total of the tetrafluoroethylene-vinylidene fluoride copolymer and the vinylidene fluoride polymer, a ratio of the tetrafluoroethylene-vinylidene fluoride copolymer is 10 mass % or more.

17. The lithium secondary battery of claim 12, wherein the separator comprises:
a porous layer (I) mainly composed of a thermoplastic resin, and
a porous layer (II) mainly composed of a filler with a heat resistance temperature of 150° C. or more.

18. The lithium secondary battery of claim 12, wherein, when manufacturing the lithium secondary battery, the non-aqueous electrolyte comprises vinylene carbonate.

19. The lithium secondary battery of claim 12, wherein, when manufacturing the lithium secondary battery, the non-aqueous electrolyte comprises a phosphonoacetate compound represented by the following general formula (2). 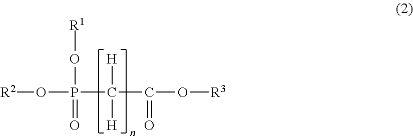
wherein in the general formula (2), each of R¹ to R³ independently represents an alkyl group, alkenyl group or alkynyl group with a carbon number of 1 to 12, with or without a halogen substituent, and n represents an integer of 0 to 6.

20. A lithium secondary battery, comprising:
a battery case shaped in a hollow column, the battery case enclosing a positive electrode a negative electrode, a non-aqueous electrolyte, and a separator,
wherein the positive electrode comprising a positive electrode mixture layer comprising a positive electrode active material, the positive electrode mixture layer provided on one side or both sides of a current collector,
wherein the positive electrode active material comprises a lithium-containing composite oxide comprising lithium and a transition metal, wherein at least a part of the lithium-containing composite oxide includes nickel as the transition metal,
wherein the negative electrode active material comprises a negative electrode mixture layer comprising: a composite of the material including Si and O as constituent elements (wherein an atom ratio x of O for Si is 0.5≦x≦1.5) with a carbon material; and a graphite carbon material, the negative electrode mixture layer provided on one side or both sides of a current collector,
wherein a content of the composite of the material including Si and O as constituent elements with the carbon material is 1 to 20 mass % in the negative electrode active material,
wherein when manufacturing the lithium secondary battery, the non-aqueous electrolyte includes a halogen-substituted cyclic carbonate at a content of 0.5 to 5 mass %,
wherein the side part of the battery case includes two wide surfaces opposed to each other,
wherein the two wide surfaces are wider than the other surfaces in a side view thereof,
wherein the side part has such a cleavable groove that is cleaved when an internal pressure of the battery exceeds a threshold,
wherein the cleavable groove is provided at a portion to intersect with a diagonal of the wide surfaces in the side view.

21. The lithium secondary battery of claim 20, wherein the carbon material, included in the composite of the material including Si and O as constituent elements with the carbon material is one produced by thermolysis when a hydrocarbon gas is heated in a vapor phase.

22. The lithium secondary battery of claim 20, wherein prior to use, the lithium secondary battery is applied to a constant-current constant-voltage charge with a stop voltage of more than 4.30V.

23. The lithium secondary battery of claim 20, wherein when manufacturing the lithium secondary battery, the non-aqueous electrolyte contains vinylene carbonate.
